(19) United States
(12) Patent Application Publication
(10) Pub. No.: US 2026/0032546 A1
(43) Pub. Date: Jan. 29, 2026

(54) Improved Master Cell Group (MCG) Recovery

(71) Applicant: Telefonaktiebolaget LM Ericsson (publ), Stockholm (SE)

(72) Inventors: Marco Belleschi, Solna (SE); Julien Muller, Rennes (FR); Ali Parichehrehteroujeni, Linköping (SE); Tahmineh Torabian Esfahani, Sollentuna (SE)

(21) Appl. No.: 19/099,364

(22) PCT Filed: Jul. 15, 2023
(86) PCT No.: PCT/SE2023/050740

§ 371 Date: Jan. 28, 2025

Related U.S. Application Data
(60) Provisional application No. 63/398,790, filed on Aug. 17, 2022.

(51) Int. Cl. H04W 36/30; H04W 36/24; H04W 76/19; H04W 76/20

(52) U.S. Cl. CPC H04W 36/305; H04W 36/249; H04W 76/19; H04W 76/20

(57) ABSTRACT

Embodiments include methods method for a user equipment (UE) configured to communicate with a radio access network (RAN) via a master cell group (MCG) provided by a first RAN node and a secondary cell group (SCG) provided by a second RAN node. Such methods include, based on detecting a failure condition in the MCG and determining that the SCG is neither deactivated nor suspended, transmitting an MCG failure report to the second RAN node via the SCG and initiating a timer associated with a fast MCG recovery procedure. Such methods include storing information associated with the fast MCG recovery procedure and subsequently transmitting, to a third RAN node, a message including the information associated with the fast MCG recovery procedure. Other embodiments include complementary methods for the first RAN node and the third RAN node, as well as UEs and RAN nodes configured to perform such methods.

### TECHNICAL FIELD

The present disclosure generally relates to wireless communication networks and particularly relates to techniques when a user equipment (UE) when connected to multiple cell groups in a wireless network and experiences a failure in one of the cell groups.

### BACKGROUND

Currently the fifth generation (5G) of cellular systems, also referred to as New Radio (NR), is being standardized within the Third-Generation Partnership Project (3GPP). NR is developed for maximum flexibility to support a variety of different use cases. These include enhanced mobile broadband (eMBB), machine type communications (MTC), ultra-reliable low latency communications (URLLC), side-link device-to-device (D2D), and several other use cases. Although the present disclosure relates primarily to 5G/NR, the following summary of fourth-generation Long-Term Evolution (LTE) technology is provided to introduce various terms, concepts, architectures, etc. that are also used in 5G/NR.

LTE is an umbrella term that refers to radio access technologies developed within 3GPP and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network.

An overall exemplary architecture of a network comprising LTE and SAE is shown in FIG. 1. The E-UTRAN (100) includes one or more evolved Node B's (eNBs, e.g., 105, 110, 115) and one or more user equipment (UEs, e.g., 120). The E-UTRAN is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, each of which can serve a geographic coverage area including one or more cells. In the E-TRAN shown in FIG. 1, eNBs 105, 110, and 115 serve cells 106, 111, and 115, respectively.

The eNBs communicate with each other via the X2 interface and with the EPC (130) via the S1 interface, specifically with the Mobility Management Entity (MME) and the Serving Gateway (SGW), as exemplified by MME/S-GWs (134, 138) in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. In contrast, the S-GW handles all Internet Protocol (IP) data packets (e.g., user plane) between the UE and the EPC and serves as the local mobility anchor for data bearers when the UE moves between eNBs.

The EPC can also include a Home Subscriber Server (HSS, 131), which manages user- and subscriber-related information. The HSS can also provide support functions in mobility management, call and session setup, user authentication and access authorization. The HSS functions can be related to the functions of legacy Home Location Register (HLR) and Authentication Centre (AuC) functions or operations. The HSS can communicate with the MMEs via respective S6a interfaces. In some embodiments, the HSS can communicate with a user data repository (EPC-UDR, e.g., 135) via a Ud interface. The EPC-UDR can store user credentials after they have been encrypted by AuC algorithms. 3GPP LTE Rel-10 supports carrier aggregation (CA) for bandwidths larger than 20 MHz.

For backward compatibility with LTE Rel-8, a wideband LTE Rel-10 carrier (e.g., wider than 20 MHz) appears as multiple carriers (“component carriers” or CCs) to Rel-8 (“legacy”) UEs but Rel-10 UEs receive all CCs of the wideband carrier via CA. LTE Rel-12 introduced dual connectivity (DC) whereby a UE is connected to two network nodes simultaneously, thereby improving connection robustness and/or capacity. In LTE DC, these two network nodes are referred to as “Master eNB” (MeNB) and “Secondary eNB” (SeNB), or more generally as master node (MN) and secondary node (SN). More specifically, a UE is configured with a Master Cell Group (MCG) provided by the MN and a Secondary Cell Group (SCG) provided by the SN. Each CG includes one MAC entity, a set of logical channels with associated RLC entities, a primary cell (PCell), and optionally one or more secondary cells (SCells).

5G/NR technology shares many similarities with 4G/LTE. For example, both physical layers (PHYs) utilize similar arrangements of time-domain physical resources into 1-ms subframes that include multiple slots of equal duration, with each slot including multiple OFDM-based symbols. Several DC (or more generally, multi-connectivity) scenarios have been considered for NR. These include NR-DC that is similar to LTE-DC discussed above, except that both MN and SN (referred to as “gNBs”) use the NR interface to communicate with a UE. In addition, 5G includes various multi-RAT DC (MR-DC) scenarios in which a UE can be configured to utilize resources of two different nodes, one providing E-UTRA/LTE access and the other one providing NR access. One node acts as the MN (e.g., providing MCG) and the other as the SN (e.g., providing SCG), with the MN and SN being connected via a network interface and at least the MN being connected to a core network (e.g., EPC or 5GC).

Seamless mobility is a key feature of 3GPP radio access technologies (RATs). In general, a RAN (e.g., NG-RAN) configures a UE to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE to declare radio link failure (RLF) or handover failure (HOF). This can occur before the UE sends a measurement report in a source cell, before the UE receives a handover command to a target cell, shortly after the UE executes a successful handover to the target cell, or upon a HOF to the target cell (e.g., upon expiry of timer T304, started when the UE starts synchronization with the target cell).

An RLF reporting procedure was introduced as part of the mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover).

In MR-DC, a UE also monitors the MCG PCell for RLF (called “M-RLF”). Once an M-RLF is detected, the UE either transmits an MCGFailureInformation message via the SCG or initiates an RRC reestablishment procedure for its connection to the RAN. Similarly, a UE in MR-DC also monitors for RLF (or other failures in the SCG) and transmits an SCGFailureInformation informing the MN about the SCG failure.

### SUMMARY

3GPP Rel-16 introduced a feature call MCG fast recovery, whereby a UE in DC that detects an M-RLF suspends only the failed radio link (e.g., to PCell) rather than performing a full reestablishment of its connection to the RAN. In particular, the UE logs the detected failure and sends an MCGFailureInformation message to the SN, including information such as UE location, latest available RRM measurements of MCG and SCG, etc. The UE initiates a timer (T316) upon transmission of MCGFailureInformation message, stops it upon reception of any message from the RAN (i.e., SN), and initiates connection reestablishment if the timer expires without receiving a message from the RAN.

The effectiveness of fast MCG recovery depends heavily on the configuration of timer T316. If the value for T316 is configured too low, the RAN may not have sufficient time to issue a reconfiguration message for the UE and handover the UE to a new cell. On the other hand, if the value for T316 is configured too high, it will cause the UE to wait too long for a responsive message from the RAN before initiating connection reestablishment.

An object of embodiments of the present disclosure is to improve MCG failure handling for UEs operating in DC with a RAN, such as by facilitating solutions to exemplary problems summarized above and described in more detail below.

Some embodiments of the present disclosure include methods (e.g., procedures) for a ULE configured to communicate with a RAN via an MCG provided by a first RAN node and an SCG provided by a second RAN node.

These exemplary methods include, based on detecting a failure condition in the MCG and determining that the SCG is neither deactivated nor suspended, transmitting an MCG failure report to the second RAN node via the SCG and initiating a timer (e.g., T316) associated with a fast MCG recovery procedure. These exemplary methods also include storing information associated with the fast MCG recovery procedure. These exemplary methods also include subsequently transmitting, to a third RAN node, a message including the information associated with the fast MCG recovery procedure

In some embodiments, the (stored) information associated with the fast MCG recovery procedure includes one or more of the following:
a RAN-configured value for the fast MCG recovery timer;
an indication of whether the fast MCG recovery timer expired before the UE received a responsive message;
an identity of the SCG cell to which the UE transmitted the MCG failure report;
an identity of the MCG cell in which the UE detected the failure condition;
time elapsed between the UE detecting the failure condition in the MCG and transmitting the failure report; and
UE location-related information associated with the detected failure condition in the MCG.

In some of these embodiments, the responsive message is one of the following: RRCRelease, RRCReconfiguration with reconfigurationwithSync for a primary cell (PCell) of the MCG, and MobilityFromNRCommand for the PCell of the MCG. In some of these embodiments, the information associated with the fast MCG recovery procedure includes one or more of the following:
value of the timer at reception of the responsive message;
time elapsed between initiating the timer and receiving the responsive message;
most recent MCG and/or SCG radio measurement results before stopping the timer;
an identity of a target MCG primary cell (PCell) indicated in the responsive message;
a type of the responsive message (e.g., RRCRelease, RRCReconfiguration with reconfigurationwithSync for a PCell of the MCG, or MobilityFromNRCommand for the PCell of the MCG); and
time elapsed between detecting the failure condition in the MCG and receiving the responsive message.

In some of these embodiments, the message including the information associated with the fast MCG recovery procedure is one of the following: a successful fast MCG recovery report, a successful handover report (SHR), and a radio link failure (RLF) report.

In other embodiments, these exemplary methods also include, upon expiry of the timer without receiving a responsive message from the second RAN node, initiating a connection reestablishment procedure with the RAN. In some of these embodiments, the information associated with the fast MCG recovery procedure includes one or more of the following:
time elapsed between the UE detecting the failure condition and initiating the connection reestablishment procedure;
most recent MCG and/or SCG radio measurement results before expiry of the timer;
an identity of a target MCG PCell towards which the UE initiated the connection reestablishment procedure;
an indication of whether the UE successfully completed the connection reestablishment procedure; and
time elapsed between detecting the failure condition in the MCG and successful completion of the connection reestablishment procedure.

In some embodiments, these exemplary methods also include receiving from the first RAN node or the second node a configuration for fast MCG recovery. The configuration includes a RAN-configured value for the timer. For example, the fast MCG recovery procedure is performed by the UE based on the RAN-configured value for the timer.

In some embodiments, the exemplary method can also include the following operations:
transmitting, to the third RAN node, an indication of availability of stored information associated with a fast MCG recovery procedure; and
receiving from the third RAN node a request for the stored information associated with the fast MCG recovery procedure.
   In such embodiments, the message including the information associated with the fast MCG recovery procedure is transmitted to the third RAN node in response to the request. In some of these embodiments, one of the following applies:
the indication is included in an RRCReestablishmentComplete message transmitted in a cell in which the UE successfully completed a connection reestablishment procedure;
the indication is included in an RRCSetupComplete message transmitted in a cell in which the UE connected to the RAN after a failed connection reestablishment procedure;
the indication is included in an RRCReconfigurationComplete message transmitted in a cell to which the UE performed a handover; or
the indication is included in an RRCResumeComplete message transmitted in a cell in which the UE returned to RRC_CONNECTED state.

Other embodiments include methods (e.g., procedures) for a third RAN node configured to communicate with a UE via a cell. In general, these embodiments are complementary to the methods for the UE that were summarized above.

These exemplary methods include receiving, from the UE via the cell, a message including information associated with a fast MCG recovery procedure performed by the UE after UE detection of a failure condition in the UE's MCG and UE transmission of an MCG failure report to a second RAN node via the UE's SCG. These exemplary methods also include, based on the received information, determining that the MCG in which the failure condition was detected was provided by a first RAN node. These exemplary methods can also include sending to the first RAN node at least a portion of the received information associated with the fast MCG recovery procedure performed by the UE.

In various embodiments, the information associated with the fast MCG recovery procedure (i.e., provided by the UE) can include any of the corresponding information summarized in above in relation to UE embodiments.

In some embodiments, when the UE received a responsive message before the fast MCG recovery timer expired, the message including the information associated with the fast MCG recovery procedure is one of the following: a successful fast MCG recovery report, a successful handover report (SHR), or a radio link failure (RLF) report.

In other embodiments, when the fast MCG recovery timer expired without the UE receiving a responsive message, the message including the information associated with the fast MCG recovery procedure is an RLF report.

In some embodiments, these exemplary methods also include the following operations:
receiving from the UE an indication of availability of stored information associated with a fast MCG recovery procedure; and
transmitting to the UE a request for the stored information associated with the fast MCG recovery procedure.
   In such embodiments, the message including the information associated with the fast MCG recovery procedure is received from the UE in response to the request. In some of these embodiments, one of the following applies:
the indication is included in an RRCReestablishmentComplete message received in a cell in which the UE successfully completed a connection reestablishment procedure;
the indication is included in an RRCSetupComplete message received in a cell in which the UE connected to the RAN after a failed connection reestablishment procedure;
the indication is included in an RRCReconfigurationComplete message received in a cell to which the UE performed a handover; or
the indication is included in an RRCResumeComplete message received in a cell in which the UE returned to RRC_CONNECTED state.

In some embodiments, the at least a portion of the information associated with the fast MCG recovery procedure is sent to the first RAN node in one of the following messages: XnAP ACCESS AND MOBILITY INDICATION, or XnAP FAILURE INDICATION.

Other embodiments include methods (e.g., procedures) for a first RAN node configured to provide an MCG for a UE that is also configured to communicate with the RAN via an SCG provided by a second RAN node. In general, these embodiments are complementary to the methods for the UE and for the third RAN node, as summarized above.

These exemplary methods include receiving, from a third RAN node, a message including information associated with a fast MCG recovery procedure performed by the UE after UE detection of a failure condition in the MCG and UE transmission of an MCG failure report to the second RAN node via the SCG. These exemplary methods also include, based on the received information, identifying a cell served by the first RAN node in which failure condition was detected. These exemplary methods also include, based on the received information, adjusting a configuration for fast MCG recovery associated with the identified cell.

In various embodiments, the information associated with the fast MCG recovery procedure (i.e., provided by the third RAN node) can include any of the corresponding information summarized above in relation to UE embodiments.

In some embodiments, the information associated with the fast MCG recovery procedure is received from to the third RAN node in one of the following messages: XnAP ACCESS AND MOBILITY INDICATION, or XnAP FAILURE INDICATION.

In some embodiments, the configuration for fast MCG recovery includes a RAN-configured value for a UE timer associated with the fast MCG recovery procedure and adjusting the configuration of fast MCG recovery includes increasing or decreasing the RAN-configured value for the UE timer based on one or more of the following included in the received information associated with the UE's fast MCG recovery procedure:
an indication of whether the UE received a responsive message from the RAN before the timer expired;
time elapsed between UE detection of the failure condition in the MCG and transmitting an MCG failure report;
value of the UE timer at UE reception of the responsive message;
time elapsed between UE detection of the failure condition and UE reception of the responsive message;
time elapsed between UE initiation of the UE timer and UE reception of the responsive message;
time elapsed between UE detection of the failure condition and UE initiation of a connection reestablishment procedure;
an indication of whether the UE successfully completed the connection reestablishment procedure; and
time elapsed between UE detection of the failure condition in the MCG and successful UE completion of the connection reestablishment.

In some embodiments, adjusting the configuration for fast MCG recovery includes modifying rules for selecting an SCG and/or a PSCell in combination with the identified cell as a primary cell (PCell) of an MCG for a UE, based on one or more of the following included in the received information associated with the fast MCG recovery procedure:
an indication of whether the UE received a responsive message from the RAN before expiry of a UE timer associated with the fast MCG recovery procedure;
an identity of the SCG cell to which the UE transmitted the MCG failure report;
UE location-related information associated with the detected failure condition in the MCG;
most recent MCG and/or SCG radio measurement results before the UE stopped the UE timer and/or the UE received the responsive message;
most recent MCG and/or SCG radio measurement results before expiry of the UE timer; and
time elapsed between UE detection of the failure condition and UE reception of the responsive message.

In some embodiments, these exemplary methods also include sending to the UE a configuration for fast MCG recovery. The configuration includes a RAN-configured value for a UE timer associated with the fast MCG recovery procedure.

In some embodiments, the third RAN node, from which the message is received, serves one of the following cells:
a cell in which the UE successfully completed a connection reestablishment procedure;
a cell in which the UE connected to the RAN after a failed connection reestablishment procedure;
a cell to which the UE performed a handover; or
a cell in which the UE returned to RRC_CONNECTED state.

Other embodiments include UEs (e.g., wireless devices, IoT devices, etc. or component(s) thereof) and RAN nodes (e.g., base stations, eNBs, gNBs, ng-eNBs, en-gNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments disclosed herein can provide various advantages, benefits, and/or solutions to problems. For example, by improving the configuration for fast MCG recovery used in a cell, the RAN can reduce average UE delay for connection recovery after a detecting failure condition in the MCG. In this manner, embodiments reduce average connection interruption time for UEs experiencing MCG failures, thereby reducing UE energy consumption and improving end-user experience. At a high level, embodiments can improve DC operations for both UEs and RANs.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary LTE network architecture.

FIG. 2 shows a high-level view of an exemplary 5G/NR network architecture.

FIG. 3 shows an exemplary configuration of NR user plane (UP) and control plane (CP) protocol stacks.

FIG. 4 shows a high-level illustration of dual connectivity (DC) in combination with carrier aggregation (CA).

FIGS. 5-6 show high-level views of exemplary network architectures that support multi-RAT DC (MR-DC) using EPC and 5GC, respectively.

FIG. 7 shows signaling for an exemplary SCG failure information procedure between a UE and a RAN.

FIG. 8 shows signaling for an exemplary Failure Indication procedure between two NG-RAN nodes.

FIG. 9 shows signaling for an exemplary Access and Mobility Indication procedure between two NG-RAN nodes, according to various embodiments of the present disclosure.

FIG. 10 shows an ASN.1 data structure for an exemplary RLF-Report information element (IE), according to various embodiments of the present disclosure.

FIG. 11 is a flow diagram of an exemplary method (e.g., procedure) for a UE, according to various embodiments of the present disclosure.

FIG. 12 is a flow diagram of an exemplary method (e.g., procedure) for a third RAN node, according to various embodiments of the present disclosure.

FIG. 13 is a flow diagram of an exemplary method (e.g., procedure) for a first RAN node, according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can operate in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

FIG. 2 illustrates a high-level view of the 5G network architecture, consisting of a Next Generation RAN (NG-RAN, 299) and a 5G Core (5GC, 298). The NG-RAN can include a set of gNodeB's (gNBs, e.g., 200, 250) connected to the 5GC via one or more NG interfaces (e.g., 202, 252). In addition, the gNBs can be connected to each other via one or more Xn interfaces (e.g., 240). With respect to the NR interface to UEs, each of the gNBs can support frequency division duplexing (FDD), time division duplexing (TDD), or a combination thereof.

The NG-RAN is layered into a Radio Network Layer (RNL) and a Transport Network Layer (TNL). The NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 200) include a Central Unit (CU or gNB-CU, e.g., 210) and one or more Distributed Units (DU or gNB-DU, e.g., 220, 230). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 222 and 232). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

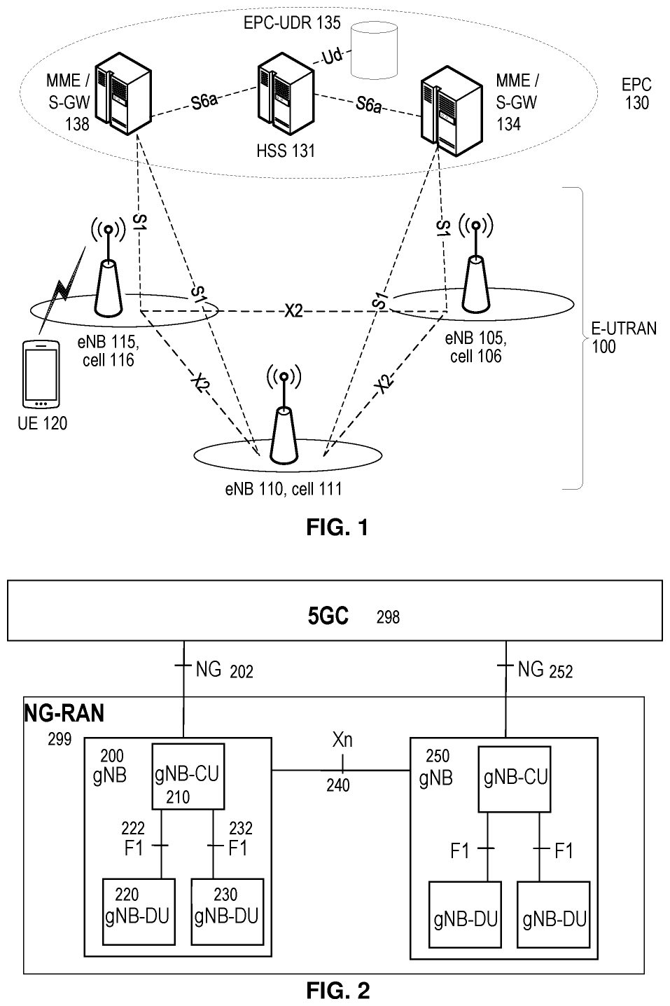

Centralized control plane protocols (e.g., PDCP-C and RRC) can be hosted in a different CU than centralized user plane protocols (e.g., PDCP-U). For example, a gNB-CU can be divided logically into a CU-CP function (including RRC and PDCP for signaling radio bearers) and CU-UP function (including PDCP for UP). A single CU-CP can be associated with multiple CU-UPs in a gNB. The CU-CP and CU-UP communicate with each other using the E1-AP protocol over the E1 interface. Furthermore, the F1 interface between CU and DU (see FIG. 1) is functionally split into F1-C between DU and CU-CP and F1-U between DU and CU-UP. Three deployment scenarios for the split gNB architecture shown in FIG. 2 are CU-CP and CU-UP centralized, CU-CP distributed/CU-UP centralized, and CU-CP centralized/CU-UP distributed.

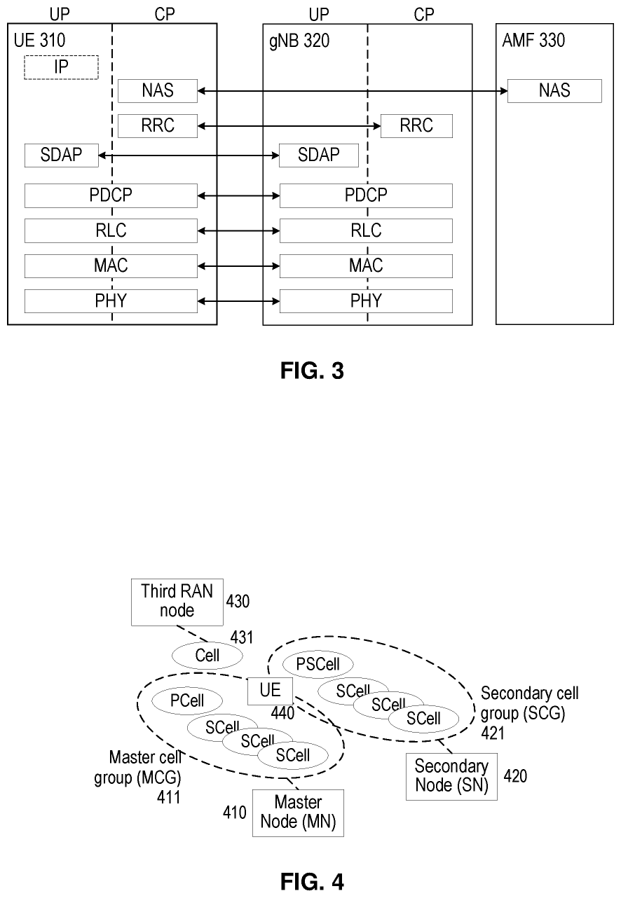

FIG. 3 shows an exemplary configuration of NR user plane (UP) and control plane (CP) protocol stacks between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

3GPP TR 38.804 (v14.0.0) describes various exemplary dual-connectivity (DC) scenarios or configurations in which the MN and SN can apply either NR, LTE, or both. The following terminology is used to describe these exemplary DC scenarios or configurations:
DC: LTE DC (i.e., both MN and SN employ LTE, as discussed above);
EN-DC: LTE-NR DC where MN (eNB) employs LTE and SN (gNB) employs NR, and both are connected to EPC.
NGEN-DC: LTE-NR dual connectivity where a UE is connected to one ng-eNB that acts as a MN and one gNB that acts as a SN. The ng-eNB is connected to the 5GC and the gNB is connected to the ng-eNB via the Xn interface.
NE-DC: LTE-NR dual connectivity where a UE is connected to one gNB that acts as a MN and one ng-eNB that acts as a SN. The gNB is connected to 5GC and the ng-eNB is connected to the gNB via the Xn interface.
NR-DC (or NR-NR DC): both MN and SN employ NR.
MR-DC (multi-RAT DC): a generalization of the Intra-E-UTRA Dual Connectivity (DC) described in TS 36.300, where a multiple Rx/Tx UE may be configured to utilize resources provided by two different nodes connected via non-ideal backhaul, one providing E-UTRA access and the other one providing NR access. One node acts as the MN and the other as the SN. The MN and SN are connected via a network interface and at least the MN is connected to the core network. EN-DC, NE-DC, and NGEN-DC are different example cases of MR-DC.

FIG. 4 shows a high-level illustration of a UE (440) arranged in DC with CA. In this illustration, each of the MN (410) and the SN (420) can be either an eNB or a gNB, in accordance with the various DC scenarios mentioned above. The MN provides the UE's MCG (411) consisting of a PCell and three SCells arranged in CA, while the SN provides the UE's SCG (421) consisting of a PSCell and three SCells arranged in CA. FIG. 4 also shows a third RAN node (430), which provides a cell (431) that is proximate to the cells of the MCG and/or the cells of the SCG. For example, the UE may communicate with the third RAN node via the cell (431) in case of failure in the MCG (or PCell) or failure in the SCG (or PSCell).

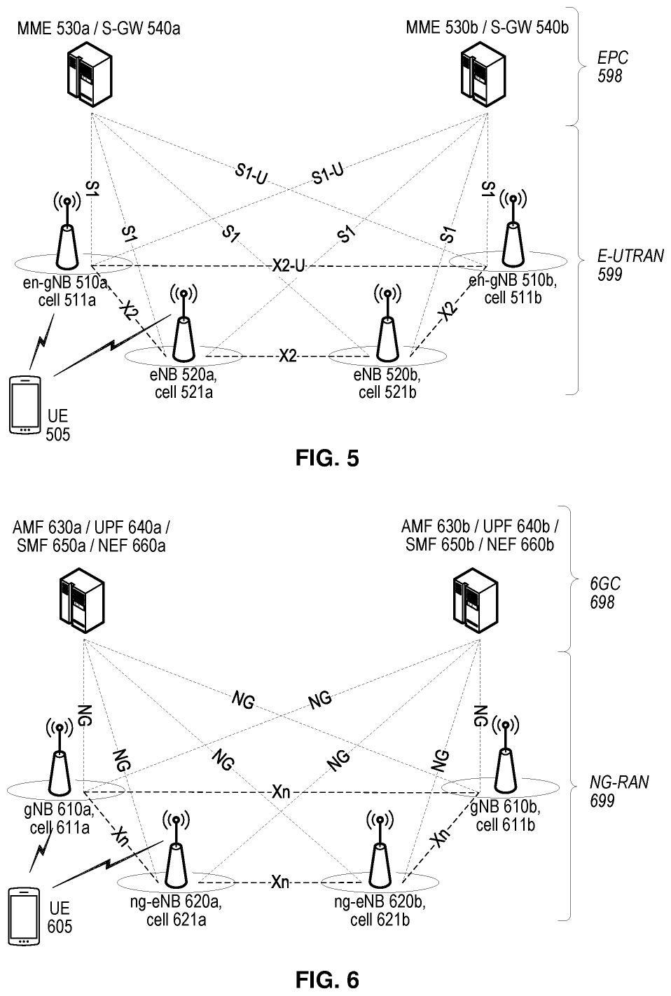

FIG. 5 shows a high-level view of an exemplary network architecture that supports EN-DC, including an E-UTRAN (599) and an EPC (598). As shown in the figure, the E-UTRAN can include en-gNBs (e.g., 510a,b) and eNBs (e.g., 520a,b) that are interconnected with each other via respective X2 (or X2-U) interfaces. The eNBs can be similar to those shown in FIG. 1, while the ng-eNBs can be similar to the gNBs shown in FIG. 3 except that they connect to EPC via an S1-U interface rather than to 5GC via an X2 interface. The eNBs also connect to EPC via an S1 interface, similar to the arrangement shown in FIG. 1. More specifically, the en-gNBs and eNBs connect to MMEs (e.g., 530a,b) and S-GWs (e.g., 540a,b) in EPC.

Each of the en-gNBs and eNBs can serve a geographic coverage area including one or more cells (e.g., 511a-b and 521a-b). Depending on the cell in which it is located, a UE (e.g., 505) can communicate with the en-gNB or eNB serving that cell via the NR or LTE radio interface, respectively. In addition, a UE can be in EN-DC connectivity with a first cell (e.g., 521a) served by an eNB (e.g., 520a) and a second cell (e.g., 511a) served by an en-gNB (e.g., 510a).

In addition to providing coverage via “cells,” as in LTE, NR networks also provide coverage via “beams.” In general, a DL “beam” is a coverage area of a network-transmitted RS that may be measured or monitored by a UE. In NR, for example, such RS can include any of the following, alone or in combination: SS/PBCH block (SSB), CSI-RS, tertiary reference signals (or any other sync signal), positioning RS (PRS), DMRS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state.

FIG. 6 shows a high-level view of an exemplary network architecture that supports MR-DC configurations based on 5GC. More specifically, FIG. 6 shows an NG-RAN (699) and a 5GC (698). The NG-RAN can include gNBs (e.g., 610a,b) and ng-eNBs (e.g., 620a,b) that are interconnected with each other via respective Xn interfaces. The gNBs and ng-eNBs are also connected via the NG interfaces to the 5GC, more specifically to the access and mobility management functions (AMFs, e.g., 630a,b) via respective NG-C interfaces and to the user plane functions (UPFs, e.g., 640a,b) via respective NG-U interfaces. Moreover, the AMFs can communicate with one or more session management functions (SMFs, e.g., 650a,b) and network exposure functions (NEFs, e.g., 660a,b).

Each of the gNBs can be similar to those shown in FIG. 5, while each of the ng-eNBs can be similar to the eNBs shown in FIG. 1 except that they connect to 5GC via an NG interface rather than to EPC via an S1 interface. Each of the gNBs and ng-eNBs can serve a geographic coverage area including one or more cells (e.g., 611a-b and 621a-b). The gNBs and ng-eNBs can also use various directional beams to provide coverage in the respective cells. Depending on the cell in which it is located, a UE (605) can communicate with the gNB or ng-eNB serving that cell via the NR or LTE radio interface, respectively. In addition, a UE can be in MR-DC with a first cell (e.g., 621a) served by an ng-eNB (e.g., 620a) and a second cell (e.g., 611a) served by a gNB (e.g., 610a).

Seamless mobility is a key feature of 3GPP radio access technologies (RATs). In general, a RAN (e.g., NG-RAN) configures a UE in RRC_CONNECTED to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE will declare radio link failure (RLF) or handover failure (HOF).

A UE typically triggers an internal RLF procedure when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell and uses that information to decide whether the UE is in-sync (IS) or out-of-sync (OOS) with respect to that serving cell. If RLM (i.e., by L1/PHY) indicates number of consecutive OOS conditions to the RRC layer, then RRC starts an RLF procedure and declares RLF after expiry of a timer (e.g., T310). The L1 RLM procedure is carried out by comparing the estimated measurements to some targets Qout and Qin, which correspond to block error rates (BLERs) of hypothetical transmissions from the serving cell. Exemplary values of Qout and Qin are 10% and 2%, respectively. In NR, the network can define RS type (e.g., CSI-RS and/or SSB), exact resources to be monitored, and the BLER target for IS and OOS indications.

In case of handover failure (HOF) and RLF, the UE may take autonomous actions such as selecting a cell and initiating reestablishment to remain reachable by the network. In general, a UE declares RLF only when the UE realizes that there is no reliable radio link available between itself and the network, which can result in poor user experience. Also, reestablishing the connection requires signaling with a newly selected cell (e.g., random access procedure, exchanging various RRC messages, etc.), which introduces latency until the UE can again reliably transmit and/or receive user data with the network. Potential causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report;
4) Reaching a maximum number of RLC retransmissions;
5) Consistent listen-before-talk (LBT failures while operating in unlicensed spectrum; and
6) Failing a beam failure recovery (BFR) procedure.
   On the other hand, HOF is caused by expiry of T304 timer while performing the handover to the target cell.

Since RLF leads to reestablishment in a new cell and degradation of UE/network performance and end-user experience, it is in the interest of the network to understand the reasons for UE RLF and to optimize mobility-related parameters (e.g., trigger conditions of measurement reports) to reduce, minimize, and/or avoid subsequent RLFs. Before Rel-9 mobility robustness optimizations (MRO), only the UE was aware of radio quality at the time of RLF, the actual reason for declaring RLF, etc.

An RLF reporting procedure was introduced as part of mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). A corresponding RLF reporting procedure was introduced as part of MRO for NR Rel-16.

In this procedure, a UE logs relevant information at the time of RLF and later reports such information to the network via a target cell to which the UE ultimately connects (e.g., after reestablishment). The UE stores an RLF report in a UE variable varRLF-Report and retains it in memory for up to 48 hours, after which it may discard the information.

When sending certain RRC messages such as RRCReconfigurationComplete, RRCReestablishmentComplete, RRCSetup-Complete, and RRCResumeComplete, the UE can indicate it has a stored RLF report by setting a rlf-InfoAvailable field to “true.” If the gNB serving the target cell wants to receive the RLF report, it sends the UE an UEInformationRequest message with a flag “rlf-ReportReq-r16”. In response, the UE sends the gNB an UEInformationResponse message that includes the RLF report.

In general, UE-reported RLF information can include any of the following:
Measurement quantities (RSRP, RSRQ) of the last serving cell (PCell).
Measurement quantities of the neighbor cells in different frequencies of different RATs (e.g., EUTRA, UTRA, GERAN, CDMA2000).
Measurement quantity (RSSI) associated to WLAN APs.
Measurement quantity (RSSI) associated to Bluetooth beacons.
Location information, if available (including location coordinates and velocity)
Globally unique identity of the last serving cell, if available, otherwise the PCI and the carrier frequency of the last serving cell.
Tracking area code of the PCell.
Time elapsed since the last reception of the ‘Handover command’ message.
C-RNTI used in the previous serving cell.
Whether or not the UE was configured with a DRB having QCI=1.

Based on a UE RLF report and knowledge of the cell in which the UE reestablished its connection, the RAN node serving the UE's original source cell can deduce whether the RLF was due to a coverage hole or handover-related parameter configurations. If the latter case, the RAN node serving the UE's original source cell can also classify the handover-related failure as too-early, too-late, or wrong-cell.

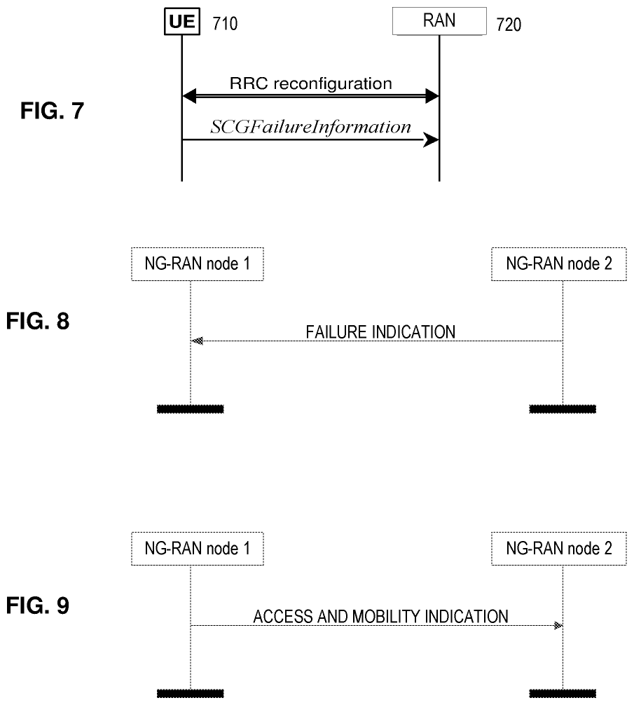

Similarly, a UE in MR-DC monitors the PSCell for RLF (called “S-RLF”) and transmits an SCGFailureInformation message informing the MN about the SCG failure. FIG. 7 shows an exemplary signal flow diagram of an NR SCG failure information procedure between a UE and a RAN (e.g., NG-RAN or E-UTRAN), during which the UE sends an SCGFailureInformation message.

The SCGFailureInformation message includes information that can facilitate RAN diagnosis of the reason for the UE's SCG failure and possibly set up a better SCG for the UE. For example, the SCGFailureInformation message includes the following information:
an indication of the failure type, e.g., timer T310 expiry, RA problems, maximum number of RLC retransmissions reached, etc.;
MCG related measurements,
SCG related measurements,
time elapsed since the last execution of RRCReconfiguration with reconfigurationWithSync for the SCG until the SCG failure; and
RA-related information.

Upon reception of the SCGFailureInformation message, the MN can determine whether to release the SN, change the SN, etc. The MN can also forward SCG measurements received within the SCGFailureInformation message to the SN, such as when the MN releases and/or modifies the UE context at the SN, when the MN requests the SN to establish, modify or release an SCG for the UE, etc.

The SCG measurements and failure type information is forwarded from MN to SN in an RRC container called CG-ConfigInfo. The field scgFailureInfo contains failure information for an NR SCG while the field scgFailureInfoEUTRA contains failure information for an LTE SCG.

The CG-ConfigInfo container can be included in any of the following messages from MN to SN:
S-NODE ADDITION REQUEST;
S-NODE RECONFIGURATION COMPLETE;
S-NODE MODIFICATION REQUEST;
S-NODE MODIFICATION REFUSE; and
S-NODE RELEASE REQUEST.
   In the case where MN receives an SCGFailureInformation message from a UE whose context is still established in the SN, the MN would typically send an S-NODE MODIFICATION REQUEST (to modify the SN) or an S-NODE RELEASE REQUEST (to release the SN).

Additionally, a UE in MR-DC monitors the MCG PCell for RLF (called “M-RLF”). Once an M-RLF is detected, the UE either transmits an MCGFailureInformation message via the SCG or initiates an RRC reestablishment procedure for its connection to the RAN. The MCGFailureInformation message includes information that can facilitate RAN diagnosis of the reason for the UE's MCG failure and possibly set up a better MCG for the UE. For example, the MCGFailureInformation message includes the following information:
an indication of the failure type, e.g., timer T310 expiry, RA problems, maximum number of RLC retransmissions reached, etc.;
MCG related measurements;
SCG related measurements; and
RA-related information.

The following exemplary text from 3GPP TS 38.331 (v17.1.0) describes UE and network operations associated with M-RLF detection and reporting:

*** Begin text from 3GPP TS 38.331 ***
5.3.10.3 Detection of radio link failure
The UE shall:

| 1> | if any DAPS bearer is configured: | |
|---|---|---|
| | | . . . |
| 1> | else: | |
| | 2> | upon T310 expiry in PCell; or |
| | 2> | upon T312 expiry in PCell; or |
| | 2> | upon random access problem indication from MCG MAC while neither T300, T301, |
| | | T304, T311 nor T319 are running; or |
| | 2> | upon indication from MCG RLC that the maximum number of retransmissions has |
| | | been reached; or |
| | 2> | if connected as an IAB-node, upon BH RLF indication received on BAP entity from the |
| | | MCG; or |
| | 2> | upon consistent uplink LBT failure indication from MCG MAC while T304 is not |
| | | running: |

| | |
|---|---|
| 3> | if the indication is from MCG RLC and CA duplication is configured and activated, |
| | and for the corresponding logical channel allowedServingCells only includes |
| | SCell(s): |

| | |
|---|---|
| 4> | initiate the failure information procedure as specified in 3GPP TS 38.331 section |
| | 5.7.5 to report RLC failure. |

| | |
|---|---|
| 3> | else: |

| | |
|---|---|
| 4> | consider radio link failure to be detected for the MCG i.e., RLF; |
| 4> | discard any segments of segmented RRC messages stored according to 3GPP TS |
| | 38.331 section 5.7.6.3; |
| 4> | store the following radio link failure information in the VarRLF-Report by setting |
| | its fields as follows: |
| | . . . |
| 4> | if AS security has not been activated: |

| | |
|---|---|
| 5> | perform the actions upon going to RRC_IDLE as specified in 3GPP TS 38.331 |
| | section 5.3.11, with release cause ‘other’;- |

| | |
|---|---|
| 4> | else if AS security has been activated but SRB2 and at least one DRB or, for IAB, |
| | SRB2, have not been setup: |

| | |
|---|---|
| 5> | store the radio link failure information in the VarRLF-Report as described in |
| | 3GPP TS 38.331 section 5.3.10.5; |
| 5> | perform the actions upon going to RRC_IDLE as specified in 3GPP TS 38.331 |
| | section 5.3.11, with release cause ‘RRC connection failure’; |

| | |
|---|---|
| 4> | else: |

| | |
|---|---|
| 5> | store the radio link failure information in the VarRLF-Report as described in |
| | subclause 5.3.10.5; |
| 5> | if T316 is configured; and |
| 5> | if SCG transmission is not suspended; and |
| 5> | if PSCell change is not ongoing (i.e., timer T304 for the NR PSCell is not |
| | running in case of NR-DC or timer T307 of the E-UTRA PSCell is not running |
| | as specified in 3GPP TS 36.331 section 5.3.10.10, in NE-DC): |

| | |
|---|---|
| 6> | initiate the MCG failure information procedure as specified in 3GPP TS |
| | 38.331 section 5.7.3b to report MCG radio link failure. |

| | |
|---|---|
| 5> | else: |

| | |
|---|---|
| 6> | initiate the connection re-establishment procedure as specified in 3GPP TS |
| | 38.331 section 5.3.7. |

*** End text from 3GPP TS 38.331 ***

As briefly mentioned above, 3GPP Rel-16 introduced a feature call MCG fast recovery, whereby a UE in DC that detects an M-RLF suspends only the failed radio link (e.g., to PCell) rather than performing a full reestablishment of its connection to the RAN. The UE initiates a timer (T316) upon transmission of MCGFailureInformation message, stops it upon reception of any message from the RAN (i.e., SN), and initiates connection reestablishment if the timer expires without receiving a message from the RAN. These operations are described in 3GPP TS 38.331 (v17.1.0) section 5.7.3b, relevant portions of which are repeated below.

*** Begin text from 3GPP TS 38.331 ***
5.7.3b.4 Actions related to transmission of MCGFailureInformation message
The UE shall set the contents of the MCGFailureInformation message as follows:

...

The UE shall:

| 1> | start timer T316; | |
|---|---|---|
| 1> | if SRB1 is configured as split SRB: | |
| | 2> | submit the MCGFailureInformation message to lower layers for transmission via |
| | | SRB1, upon which the procedure ends; |
| 1> | else (i.e., SRB3 configured): | |
| | 2> | submit the MCGFailureInformation message to lower layers for transmission |
| | | embedded in NR RRC message ULInformationTransferMRDC via SRB3 as specified |
| | | in 3GPP TS 38.331 section 5.7.2a.3. |

5.7.3b.5 T316 expiry
The UE shall:

| 1> | if T316 expires: | |
|---|---|---|
| | 2> | initiate the connection re-establishment procedure as specified in 3GPP TS 38.331 |
| | | section 5.3.7. |

*** End text from 3GPP TS 38.331 ***

To summarize, if fast MCG recovery is configured (i.e., T316 configured), upon experiencing M-RLF the UE may attempt to recover its connection by sending an MCGFailureInformation message via the SCG. Upon reception of the MCGFailureInformation message, the RAN may configure a new MCG so that the UE does not need to perform reestablishment, which can negatively impact UE performances. Before transmitting the MCGFailureInformation message, the UE needs to determine whether the SCG is available. For example, the SCG may have been deactivated by the RAN so that the UE can stop performing radio link monitoring and beam failure detection on the SCG, which reduces UE energy consumption. In particular, the RAN can deactivate the UE's SCG without releasing the entire SCG configuration. As another example, SCG operations might have been suspended by the UE as a consequence of an RLF detected in the SCG.

If instead of sending an MCGFailureInformation message the UE triggers connection re-establishment, the UE includes an indication that an RLF report is available in the RRCReestablishmentComplete message. In this manner, the RAN node where the UE has re-established its connection can retrieve the RLF report by sending a UEInformationRequest message, to which the UE responds with a UEInformationResponse including the RLF report. Based on this information, the reestablishment RAN node can determine the cell where the RLF occurred and forward the RLF report to the RAN node serving that cell.

FIG. 8 shows exemplary signaling for a Failure Indication procedure defined in 3GPP TS 38.423 (v17.1.0), used to transfer between RAN nodes information about RRC re-establishment attempts or received RLF Reports. In FIG. 8, NG-RAN node 2 corresponds to the RAN node at which a re-establishment attempt is made and/or an RLF Report is received, while NG-RAN node 1 corresponds to the RAN node associated with the UE's connection failure. The FAILURE INDICATION message in FIG. 8 is non-UE-associated signaling, and includes a UE RLF Report Container IE.

Upon receiving a report about MCG failure from the UE's SN, the MN can send the SN an RRCReconfiguration with sync that includes a new MCG configuration for the UE, which the SN can provide to the UE. Alternately, the MN can provide an RRCRelease or MobilityFromNRCommand message for the SN to send to the UE. In this manner, the fast MCG recovery mechanism allows the UE to avoid connection reestablishment upon MCG failure. However, the UE initiates connection reestablishment if timer T316 expires after sending an MCGFailureInformation message without receiving any of these responsive messages from SN.

The effectiveness of fast MCG recovery depends heavily on the configuration of timer T316. If the value for T316 is configured too low, the RAN may not have sufficient time before expiry to analyze the MCGFailureInformation content, issue a reconfiguration message for the UE, and handover the UE to a new cell. On the other hand, if the value for T316 is configured too high, it will cause the UE to wait too long for a responsive message from the RAN until T316 expiry causes the UE to initiate connection reestablishment. This further delays UE connection recovery compared to if the UE had initially performed connection reestablishment instead of waiting for T316 expiry.

Embodiments of the present disclosure address these and other problems, difficulties, or issues by providing techniques for a UE that performs a fast MCG recovery procedure (e.g., from a detected failure condition in the MCG), including initiating timer T316, to provide to the RAN various information about the UE's fast MCG recovery procedure in a subsequent report. Such information can include configured and terminal values of T316 during the fast MCG recovery procedure. Based on receiving this information, the RAN can analyze and possibly improve configuration of fast MCG recovery in the MCG where the failure condition was detected, including the RAN-configured value used for timer T316.

Embodiments of the present disclosure can provide various advantages, benefits, and/or solutions to problems. For example, by improving the configuration for fast MCG recovery used in a cell, the RAN can reduce average UE delay for connection recovery after a detecting failure condition in the MCG. In this manner, embodiments reduce average connection interruption time for UEs experiencing MCG failures, thereby reducing UE energy consumption and improving end-user experience.

Although embodiments are described in the context of recovery from a failure of an NR or LTE MCG for a UE arranged in DC, embodiments are equally applicable to recovery from a failure of an NR or LTE SCG for a UE arranged in DC. More generally, embodiments are applicable any scenario in which a UE with multiple connections to a RAN detects a failure in a first one of the connections and decides between two failure recovery mechanisms based on link quality of a second one of the connections.

Embodiments include methods for a UE configured to communicate with a RAN via an MCG (provided by a first RAN node) and an SCG (provided by a second RAN node). Upon detecting a failure condition (e.g., RLF) in the MCG and determining that the SCG is active (i.e., neither deactivated nor suspended), the UE transmits an MCG failure report (e.g., MCGFailureInformation message) to the second RAN node via the SCG and initiates a fast MCG recovery timer (e.g., T316) upon transmitting the MCG failure report.

In some embodiments, the UE can receive a responsive message from the second RAN node while the fast MCG recovery timer is running, and stop the fast MCG recovery timer upon receiving the message. For example, the message can be an RRCRelease, an RRCReconfiguration with reconfigurationwithSync for the PCell, a MobilityFromNRCommand, or any appropriate RRC message that causes the UE to stop the fast MCG recovery.

In other embodiments, the fast MCG recover timer expires without the UE receiving a responsive message from the second RAN node. In such case, the UE initiates a connection reestablishment procedure with the RAN.

In both cases, the UE stores information associated with the fast MCG recovery procedure, which the UE can later transmit to the RAN, e.g., in an MCG failure report or other appropriate message. The stored information can include one or more of the following:
RAN-configured value for fast MCG recovery timer;
an indication of whether the fast MCG recovery timer expired before receiving a responsive message;
an identity of the SCG cell (e.g., PSCell) to which the UE transmitted the MCG failure report (e.g., MCGFailureInformation message);
an identity of the MCG cell (e.g., PCell) in which the failure condition was detected;
most recent MCG and/or SCG radio measurement results before initiating the fast MCG recovery timer;
time elapsed between detecting the failure condition in the MCG and transmitting the MCG failure report; and
UE location-related information associated with the detected failure condition in the MCG (e.g., GNSS, Bluetooth, WLAN, other sensors, etc. at or proximate to time of detecting the failure condition).

In case the UE received a responsive message before the fast MCG recovery timer expired, the stored information can also include one or more of the following:
terminal value of the fast MCG recovery timer (i.e., at time of receiving the responsive message);
time elapsed between initiating the fast MCG recovery timer and receiving the responsive message;
most recent MCG and/or SCG radio measurement results before stopping the fast MCG recovery timer;
a type of the responsive message;
an identity of a target MCG PCell indicated in the responsive message; and
time elapsed between detecting the failure condition in the MCG and receiving the responsive message.

In case the fast MCG recovery timer expired without the UE receiving a responsive message, the stored information can also include one or more of the following:
time elapsed between detecting the failure condition in the MCG and initiating the connection reestablishment procedure;
most recent MCG and/or SCG radio measurement results before expiry of the fast MCG recovery timer;
an identity of a target MCG PCell towards which the UE initiated the connection reestablishment procedure;
an indication of whether the connection reestablishment procedure was completed successfully; and
time elapsed between detecting the failure condition in the MCG and successful completion of the connection reestablishment procedure.

In some embodiments, when the fast MCG recovery procedure is successful, the UE can transmit the stored information associated with the fast MCG recovery procedure in a newly defined reporting message, such as a “successful fast MCG recovery report.” In various embodiments, the successful fast MCG recovery report can be transmitted in response to a request from the RAN (i.e., for such a report), or at UE discretion without a request from the RAN.

In other embodiments, when the fast MCG recovery procedure is successful, the UE can include the stored information in an existing message sent in association with the fast MCG recovery procedure. For example, if the responsive message from the RAN is an RRCReconfiguration with reconfigurationwithSync or a MobilityFromNRCommand, the UE can include the stored information in a successful handover report (SHR). As another example, if the responsive message from the RAN is an RRCRelease, the UE can include the stored information in an RRCSetupComplete message.

As another example, the UE can include the stored information associated with the (successful) fast MCG recovery procedure in an RLF report. This approach is different than the current 3GPP specifications, which requires the UE to delete MCG-related measurements upon stopping T316 in relation to the responsive message.

In other embodiments, when the fast MCG recovery procedure is unsuccessful (i.e., fast MCG recover timer expires), the UE can transmit the stored information associated with the fast MCG recovery procedure in an RRCReconfigurationComplete message or any other appropriate RRC message during or after the connection reestablishment procedure.

Other embodiments include methods for a third RAN node configured to communicate with a UE. The third RAN node can receive from the UE a message including information associated with a fast MCG recovery procedure performed by the UE after detecting a failure condition in the UE's MCG. The information associated with the fast MCG recovery procedure can include any of the same information discussed above in relation to UE embodiments.

Based on the received information, the third RAN node can determine that the MCG, in which the failure condition was detected, was provided by a first RAN node. The third RAN node then sends to the first RAN node at least a portion of the information associated with the fast MCG recovery procedure, that was received from the UE.

In some embodiments, the at least a portion of the information associated with the fast MCG recovery procedure is sent to the first RAN node in a new IE or container included in an existing XnAP ACCESS AND MOBILITY INDICATION message. In other embodiments, the at least a portion of the information associated with the fast MCG recovery procedure is sent to the first RAN node in a Successful HO Report IE in the existing XnAP ACCESS AND MOBILITY INDICATION message.

In other embodiments, the at least a portion of the information associated with the fast MCG recovery procedure is sent to the first RAN node in a newly defined XnAP message (i.e., defined to carry that information). In other embodiments, the at least a portion of the information associated with the fast MCG recovery procedure is sent to the first RAN node in an RLF Report IE within an existing XnAP FAILURE INDICATION message

In some embodiments, the third RAN node is the RAN node serving the cell in which the UE performed connection reestablishment. In other embodiments, the third RAN node is the RAN node serving the cell in which the UE connects after going to RRC_IDLE (e.g., after failed connection reestablishment). In other embodiments, the third RAN node is the RAN node serving the cell to which the UE performed a handover, based on receiving a handover command from the first RAN node that provided the MCG in which the failure condition was detected.

Other embodiments include methods for a first RAN node configured to provide an MCG for a UE that is also configured to communicate with the RAN via an SCG provided by a second RAN node. The first RAN node can receive, from a third RAN node, a message including information associated with a fast MCG recovery procedure performed by the UE after detecting a failure condition in the MCG. The information associated with the fast MCG recovery procedure can include any of the same information discussed above in relation to UE embodiments. The message can be any of the messages discussed above in relation to third RAN node embodiments.

Based on the received information, the first RAN node can identify the cell in which failure condition was detected (e.g., UE's PCell) and adjust configuration of fast MCG recovery procedures associated with that cell. For example, the first RAN node can increase or decrease the T316 value used to configure UEs for fast MCG recovery. As another example, the first RAN node can adjust PSCell assignment rules and/or configuration used in that cell, such that UEs are more likely to be assigned a PSCell/SCG in which fast MCG recovery will succeed.

FIG. 9 shows exemplary signaling for an Access and Mobility Indication procedure defined in 3GPP TS 38.423 (v17.1.0), used to transfer access and mobility-related information between RAN nodes. In FIG. 9, NG-RAN node 1 corresponds to the second RAN node that receives the information associated with the fast MCG recovery procedure from the UE, while NG-RAN node 2 corresponds to the first RAN node associated with the MCG failure condition.

Table 1 below shows exemplary contents of the XnAP ACCESS AND MOBILITY INDICATION message sent from NG-RAN node 1 to NG-RAN node 2. Of particular interest if the Fast MCG Recovery Report IE, which contains one or more Fast MCG Recovery Report Containers, each including a single Fast MCG Recovery Report field that carries the UE-provided information associated with a fast MCG recovery procedure. For example, up to 64 containers can be included in the Fast MCG Recovery Report IE.

TABLE 1

| | | | | Semantics |
|---|---|---|---|---|
| IE/Group Name | Pres. | Range | IE type/ref. | description |
| Message Type | M | | 9.2.3.1 | |
| RACH Report List | | 0 . . . 1 | | |
| >RACH Report List | | 1 . . . <maxnoofRACHReports> | | |
| Item | | | | |
| >>RACH Report | O | | OCTET | RA-ReportList-r16 IE |
| Container | | | STRING | as defined in |
| | | | | subclause 6.2.2 in TS |
| | | | | 38.331 [10]. |
| >>UE Assistant | O | | NG-RAN node | |
| Identifier | | | UE XnAP ID | |
| | | | 9.2.3.16 | |
| Successful HO Report | | 0 . . . 1 | | |
| List | | | | |
| >Successful HO | | 1 . . . <maxnoofSuccessfulHOReports> | | |
| Report List Item | | | | |
| >>Successful HO | O | | OCTET | SuccessHO-Report- |
| Report Container | | | STRING | r17 IE as defined in |
| | | | | subclause 6.2.2 in TS |
| | | | | 38.331 [10]. |
| Fast MCG Recovery | | 0 . . . 1 | | |
| Report | | | | |
| >Fast MCG | | 1 . . . <maxnoofFastMCGRecoveryReports> | | |
| Recovery Report | | | | |
| >>Fast MCG | O | | OCTET | Fast MCG Recovery |
| Recovery Report | | | STRING | Report as defined in |
| Container | | | | TS 38.331 [10]. |

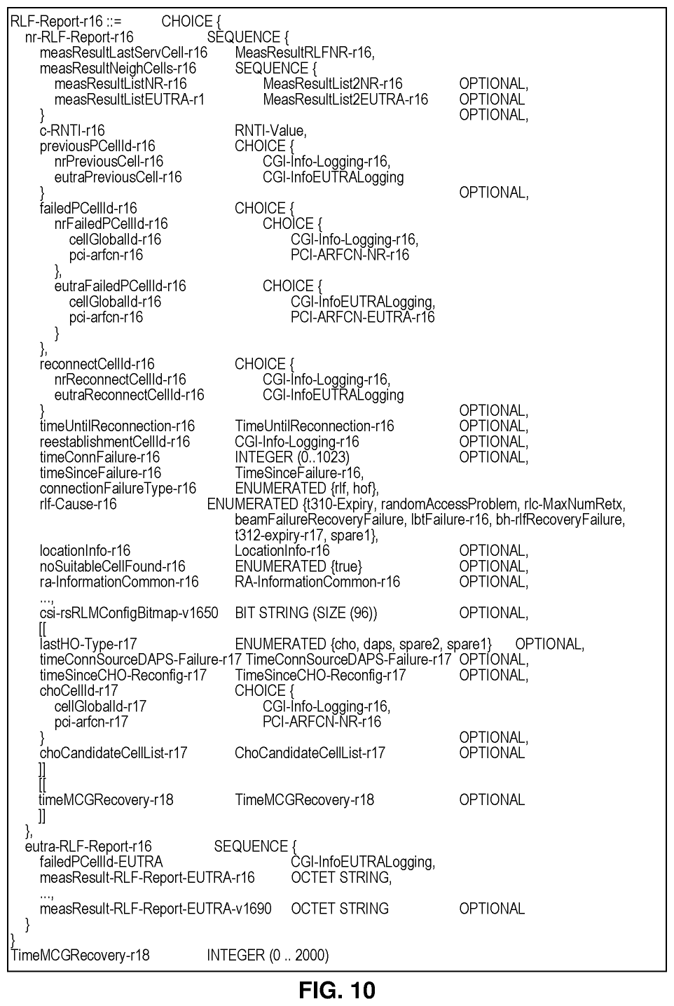

FIG. 10 shows an ASN.1 data structure for an exemplary RLF-Report IE, according to various embodiments of the present disclosure. In this message, the field timeMCGRecovery is of particular interest. This field indicates time elapsed between initiating timer T316 (i.e., start of MCG recovery) and successful completion of fast MCG recovery (e.g., reception of RRC message in response to the MCGFailureInformation message). In case of MCG recovery failure this field indicates timer T316 value configured by the network. The field timeMCGRecovery can take on any integer value from zero to 2000, with the respective integer values representing different elapsed times on a linear or non-linear scale.

Certain variants of the techniques described above can also be embodied as procedural text in 3GPP specifications. For example, the following exemplary text for 3GPP TS 38.331 illustrates how a UE can set a value for the field timeMCGRecovery discussed above in relation to FIG. 10. Note that underline and strikethrough are used to indicate changes to v17.1.0.

*** Begin exemplary text for 3GPP TS 38.331 ***
5.3.5.5.2 Reconfiguration with sync
The UE shall perform the following actions to execute a reconfiguration with sync.

| 1> | if the AS security is not activated, perform the actions upon going to RRC_IDLE as | |
|---|---|---|
| | specified in 5.3.11 with the release cause ‘other’ upon which the procedure ends; | |
| 1> | if no DAPS bearer is configured: | |
| | 2> | stop timer T310 for the corresponding SpCell, if running; |
| 1> | if this procedure is executed for the MCG: | |
| | 2> | if timer T316 is running; |

| | |
|---|---|
| 3> | stop timer T316; |
| 3> | set timeMCGRecovery to the time |
| | between the initiation of the |
| | MCGFailureInformation and the |
| | successful completion of |
| | MCG link recovery in VarRLF-Report; |

| | |
|---|---|
| | [symbol] [symbol] [symbol] [symbol] |
| 2> | resume MCG transmission, if suspended. |

...
*** End exemplary text for 3GPP TS 38.331 ***

The following text for 3GPP TS 38.331 shows another example of how a UE can set a value for the field timeMCGRecovery discussed above in relation to FIG. 10. Note that underline and strikethrough are used to indicate changes to v17.1.0.

*** Begin exemplary text for 3GPP TS 38.331 ***
5.3.5.5.2 Reconfiguration with sync
The UE shall perform the following actions to execute a reconfiguration with sync.

| 1> | if the AS security is not activated, perform the actions upon going to RRC_IDLE as | |
|---|---|---|
| | specified in 5.3.11 with the release cause ‘other’ upon which the procedure ends; | |
| 1> | if no DAPS bearer is configured: | |
| | 2> | stop timer T310 for the corresponding SpCell, if running; |
| 1> | if this procedure is executed for the MCG: | |
| | 2> | if timer T316 is running; |
| | | 3> stop timer T316; |
| | | 3> set timeMCGRecovery to the timer |
| | | T316 value in VarRLF-Report; |
| | | [symbol] [symbol] [symbol] [symbol] [symbol] |
| | 2> | resume MCG transmission, if suspended. |

...
*** End exemplary text for 3GPP TS 38.331 ***

The following text for 3GPP TS 38.331 shows another example of how a UE can set a value for the field timeMCGRecovery discussed above in relation to FIG. 10. Note that underline and strikethrough are used to indicate changes to v17.1.0.

*** Begin exemplary text for 3GPP TS 38.331 ***
5.7.3b.5 T316 expiry
The UE shall:

| | |
|---|---|
| 1> | if T316 expires: |
| | 2> set timeMCGRecovery to the timer T316 value in VarRLF-Report; |
| | 2> initiate the connection re-establishment procedure as specified in 5.3.7. |

*** End exemplary text for 3GPP TS 38.331 ***

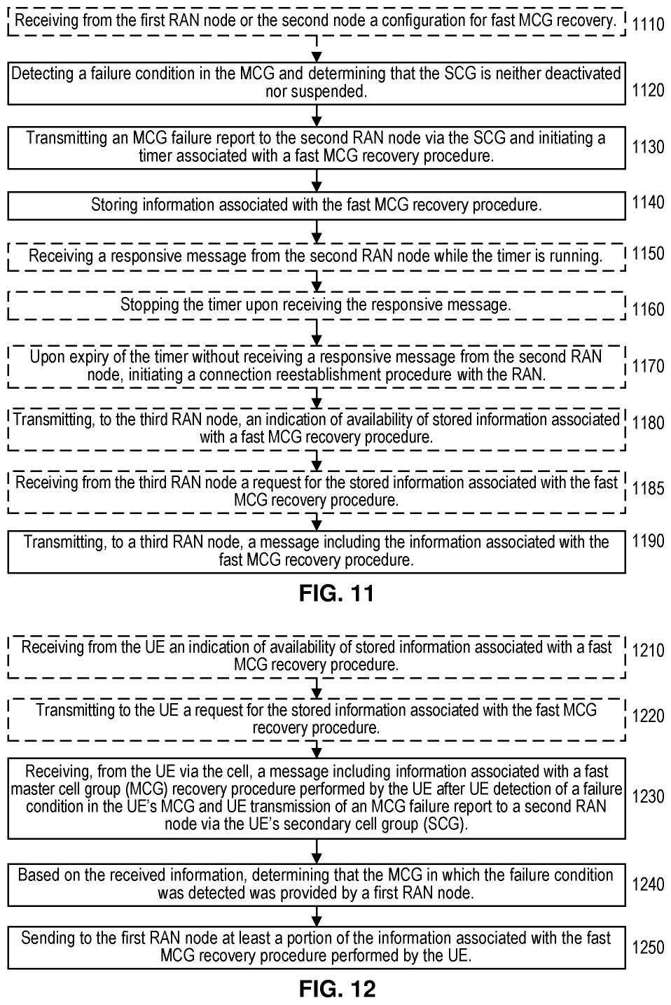

The embodiments described above can be further illustrated with reference to FIGS. 11-13, which show exemplary methods (e.g., procedures) performed by a UE, a third RAN node, and a first RAN node, respectively. In other words, various features of operations described below correspond to various embodiments described above. These exemplary methods can be used cooperatively to provide various exemplary benefits and/or advantages. Although FIGS. 11-12 show specific blocks in a particular order, the operations of the respective methods can be performed in different orders than shown and can be combined and/or divided into blocks having different functionality than shown. Optional blocks or operations are indicated by dashed lines.

In particular, FIG. 11 shows a flow diagram of an exemplary method (e.g., procedure) for a UE configured to communicate with a RAN via an MCG provided by a first RAN node and an SCG provided by a second RAN node, according to various embodiments of the present disclosure. The exemplary method can be performed by a UE (e.g., wireless device, IoT device, modem, etc. or component thereof) such as described elsewhere herein.

The exemplary method can include operations of blocks 1120-1130, where based on detecting a failure condition in the MCG and determining that the SCG is neither deactivated nor suspended, the UE can transmit an MCG failure report to the second RAN node via the SCG and initiate a timer associated with a fast MCG recovery procedure. The exemplary method can also include operations of block 1140, where the UE can store information associated with the fast MCG recovery procedure. The exemplary method can also include the operations of block 1190, where the UE can subsequently transmit, to a third RAN node, a message including the information associated with the fast MCG recovery procedure

In some embodiments, the (stored) information associated with the fast MCG recovery procedure includes one or more of the following:
a RAN-configured value for the fast MCG recovery timer;
an indication of whether the fast MCG recovery timer expired before the UE received a responsive message;
an identity of the SCG cell to which the UE transmitted the MCG failure report;
an identity of the MCG cell in which the UE detected the failure condition;
time elapsed between the UE detecting the failure condition in the MCG and transmitting the failure report; and
UE location-related information associated with the detected failure condition in the MCG.

In some embodiments, the exemplary method can also include the operations of blocks 1150-1160, where the UE can receive a responsive message from the second RAN node while the timer is running and stop the timer upon receiving the responsive message. In some of these embodiments, the responsive message is one of the following: RRCRelease, RRCReconfiguration with reconfigurationwithSync for a primary cell (PCell) of the MCG, and MobilityFromNRCommand for the PCell of the MCG.

In some of these embodiments, the information associated with the fast MCG recovery procedure (e.g., transmitted in block 1190) includes one or more of the following:
value of the timer at reception of the responsive message;
time elapsed between initiating the timer and receiving the responsive message;
most recent MCG and/or SCG radio measurement results before stopping the timer;
an identity of a target MCG primary cell (PCell) indicated in the responsive message;
a type of the responsive message (e.g., RRCRelease, RRCReconfiguration with reconfigurationwithSync for a PCell of the MCG, or MobilityFromNRCommand for the PCell of the MCG); and
time elapsed between detecting the failure condition in the MCG and receiving the responsive message.

In some of these embodiments, the message including the information associated with the fast MCG recovery procedure is one of the following: a successful fast MCG recovery report, a successful handover report (SHR), and a radio link failure (RLF) report.

In other embodiments, the exemplary method can also include the operations of block 1170, where upon expiry of the timer without receiving a responsive message from the second RAN node, the UE can initiate a connection reestablishment procedure with the RAN. In some of these embodiments, the message including the information associated with the fast MCG recovery procedure is an RLF report. In some of these embodiments, the information associated with the fast MCG recovery procedure (e.g., transmitted in block 1190) includes one or more of the following:
time elapsed between the detecting the failure condition in the MCG and initiating the connection reestablishment procedure;
most recent MCG and/or SCG radio measurement results before expiry of the timer;
an identity of a target MCG PCell towards which the UE initiated the connection reestablishment procedure;
an indication of whether the UE successfully completed the connection reestablishment procedure; and
time elapsed between detecting the failure condition in the MCG and successful completion of the connection reestablishment procedure.

In some embodiments, the exemplary method can also include the operations of block 1110, where the UE can receive from the first RAN node or the second node a configuration for fast MCG recovery. The configuration includes a RAN-configured value for the timer. For example, the fast MCG recovery procedure is performed by the UE based on the RAN-configured value for the timer.

In some embodiments, the MCG failure report transmitted to the second RAN node is an RRC MCGFailureInformation message. In some embodiments, the exemplary method can also include the following operations, labelled with corresponding block numbers:
(1180) transmitting, to the third RAN node, an indication of availability of stored information associated with a fast MCG recovery procedure; and
(1185) receiving from the third RAN node a request for the stored information associated with the fast MCG recovery procedure.
   In such embodiments, the message including the information associated with the fast MCG recovery procedure is transmitted to the third RAN node in response to the request. In some of these embodiments, one of the following applies:
the indication is included in an RRCReestablishmentComplete message transmitted in a cell in which the UE successfully completed a connection reestablishment procedure;
the indication is included in an RRCSetupComplete message transmitted in a cell in which the UE connected to the RAN after a failed connection reestablishment procedure;
the indication is included in an RRCReconfigurationComplete message transmitted in a cell to which the UE performed a handover; or
the indication is included in an RRCResumeComplete message transmitted in a cell in which the UE returned to RRC_CONNECTED state.

In addition, FIG. 12 shows a flow diagram of an exemplary method (e.g., procedure) for a third RAN node configured to communicate with a UE via a cell, according to various embodiments of the present disclosure. The exemplary method can be performed by a RAN node (e.g., base station, eNB, gNB, ng-eNB, en-gNB, etc., or components thereof) such as described elsewhere herein.

The exemplary method can include the operations of block 1230, where the third RAN node can receive, from the UE via the cell, a message including information associated with a fast MCG recovery procedure performed by the UE after UE detection of a failure condition in the UE's MCG and UE transmission of an MCG failure report to a second RAN node via the UE's SCG. The exemplary method can also include the operations of block 1240, where based on the received information, the third RAN node can determine that the MCG in which the failure condition was detected was provided by a first RAN node. The exemplary method can also include the operations of block 1250, where the third RAN node can send to the first RAN node at least a portion of the received information associated with the fast MCG recovery procedure performed by the UE.

In various embodiments, the information associated with the fast MCG recovery procedure (i.e., provided by the UE) can include any of the corresponding information described above in relation to the UE embodiments illustrated by FIG. 11.

In some embodiments, when the UE received a responsive message before the fast MCG recovery timer expired, the message including the information associated with the fast MCG recovery procedure is one of the following: a successful fast MCG recovery report, a successful handover report (SHR), or a radio link failure (RLF) report.

In other embodiments, when the fast MCG recovery timer expired without the UE receiving a responsive message, the message including the information associated with the fast MCG recovery procedure is an RLF report.

In some embodiments, the exemplary method can also include the following operations, labelled with corresponding block numbers:
(1210) receiving from the UE an indication of availability of stored information associated with a fast MCG recovery procedure; and
(1220) transmitting to the UE a request for the stored information associated with the fast MCG recovery procedure.

In such embodiments, the message including the information associated with the fast MCG recovery procedure is received from the UE in response to the request. In some of these embodiments, one of the following applies:
the indication is included in an RRCReestablishmentComplete message received in a cell in which the UE successfully completed a connection reestablishment procedure;
the indication is included in an RRCSetupComplete message received in a cell in which the UE connected to the RAN after a failed connection reestablishment procedure;
the indication is included in an RRCReconfigurationComplete message received in a cell to which the UE performed a handover; or
the indication is included in an RRCResumeComplete message received in a cell in which the UE returned to RRC_CONNECTED state.

In some embodiments, the at least a portion of the information associated with the fast MCG recovery procedure is sent to the first RAN node (e.g., in block 1230) in one of the following messages: XnAP ACCESS AND MOBILITY INDICATION, or XnAP FAILURE INDICATION.

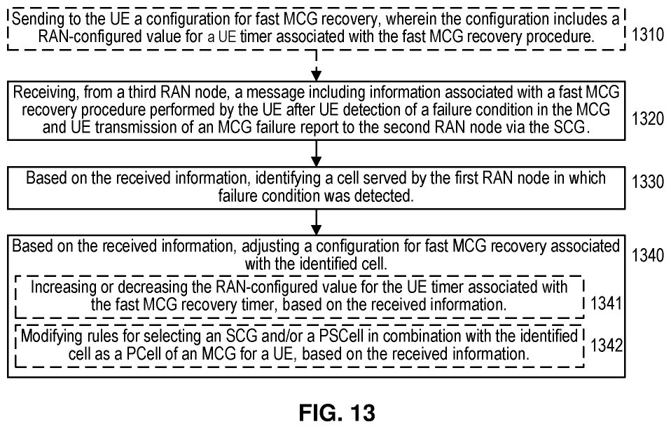

In addition, FIG. 13 shows a flow diagram of an exemplary method (e.g., procedure) for a first RAN node configured to provide an MCG for a UE that is also configured to communicate with the RAN via an SCG provided by a second RAN node, according to various embodiments of the present disclosure. The exemplary method can be performed by a RAN node (e.g., base station, eNB, gNB, ng-eNB, en-gNB, etc., or components thereof) such as described elsewhere herein.

The exemplary method can include the operations of block 1320, where the first RAN node can receive, from a third RAN node, a message including information associated with a fast MCG recovery procedure performed by the UE after UE detection of a failure condition in the MCG and UE transmission of an MCG failure report to the second RAN node via the SCG. The exemplary method can also include the operations of block 1330, where based on the received information, the first RAN node can identify a cell served by the first RAN node in which failure condition was detected. The exemplary method can also include the operations of block 1340, where based on the received information, the first RAN node can adjust a configuration for fast MCG recovery associated with the identified cell.

In various embodiments, the information associated with the fast MCG recovery procedure (i.e., provided by the third RAN node) can include any of the corresponding information described above in relation to the UE embodiments illustrated by FIG. 11.

In some embodiments, the information associated with the fast MCG recovery procedure is received from to the third RAN node in one of the following messages: XnAP ACCESS AND MOBILITY INDICATION, or XnAP FAILURE INDICATION.

In some embodiments, the configuration for fast MCG recovery includes a RAN-configured value for a UE timer associated with the fast MCG recovery procedure and adjusting the configuration of fast MCG recovery in block 1340 includes the operations of sub-block 1341, where the first RAN node can increase or decrease the RAN-configured value for the UE timer based on one or more of the following included in the received information associated with the UE's fast MCG recovery procedure:
an indication of whether the UE received a responsive message from the RAN before the timer expired;
time elapsed between UE detection of the failure condition in the MCG and transmitting an MCG failure report;
value of the UE timer at UE reception of the responsive message;
time elapsed between UE detection of the failure condition and UE reception of the responsive message;
time elapsed between UE initiation of the UE timer and UE reception of the responsive message;
time elapsed between UE detection of the failure condition and UE initiation of a connection reestablishment procedure;
an indication of whether the UE successfully completed the connection reestablishment procedure; and
time elapsed between UE detection of the failure condition in the MCG and successful UE completion of the connection reestablishment.

In some embodiments, adjusting the configuration of fast MCG recovery in block 1340 includes the operations of sub-block 1342, where the first RAN node can modify rules for selecting an SCG and/or a PSCell in combination with the identified cell as a primary cell (PCell) of an MCG for a UE, based on one or more of the following included in the received information associated with the fast MCG recovery procedure:
an indication of whether the UE received a responsive message from the RAN before expiry of a UE timer associated with the fast MCG recovery procedure;
an identity of the SCG cell to which the UE transmitted the MCG failure report;
UE location-related information associated with the detected failure condition in the MCG;
most recent MCG and/or SCG radio measurement results before the UE stopped the UE timer and/or the UE received the responsive message;
most recent MCG and/or SCG radio measurement results before expiry of the UE timer; and
time elapsed between UE detection of the failure condition and UE reception of the responsive message.

In some embodiments, the exemplary method can also include the operations of block 1310, where the first RAN node can send to the UE a configuration for fast MCG recovery. The configuration includes a RAN-configured value for a UE timer associated with the fast MCG recovery procedure. In such case, the fast MCG recovery procedure performed by the UE after detecting a failure condition in the MCG is based on the initial value.

In some embodiments, the third RAN node, from which the message is received (e.g., in block 1320), serves one of the following cells:
a cell in which the UE successfully completed a connection reestablishment procedure;
a cell in which the UE connected to the RAN after a failed connection reestablishment procedure;
a cell to which the UE performed a handover; or
a cell in which the UE returned to RRC_CONNECTED state.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

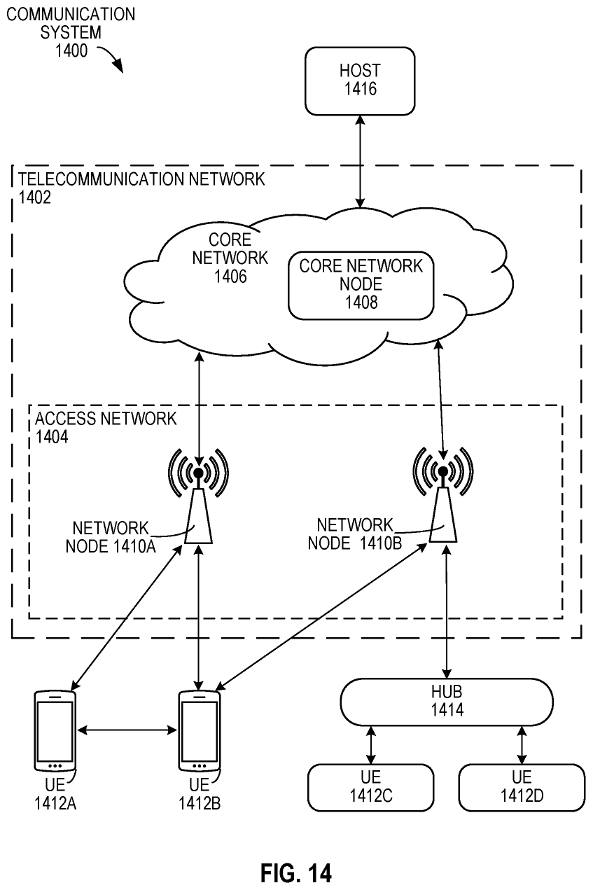

FIG. 14 shows an example of a communication system 1400 in accordance with some embodiments. In this example, communication system 1400 includes a telecommunication network 1402 that includes an access network 1404 (e.g., RAN) and a core network 1406, which includes one or more core network nodes 1408. Access network 1404 includes one or more access network nodes, such as network nodes 1410a-b (one or more of which may be generally referred to as network nodes 1410), or any other similar 3GPP access node or non-3GPP access point. Network nodes 1410 facilitate direct or indirect connection of UEs, such as by connecting UEs 1412a-d (one or more of which may be generally referred to as UEs 1412) to core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1400 may include any number of wired or wireless networks, network nodes, UEs, and/or any other components or systems that may facilitate or participate in the communication of data and/or signals whether via wired or wireless connections. Communication system 1400 may include and/or interface with any type of communication, telecommunication, data, cellular, radio network, and/or other similar type of system.

UEs 1412 may be any of a wide variety of communication devices, including wireless devices arranged, configured, and/or operable to communicate wirelessly with network nodes 1410 and other communication devices. Similarly, network nodes 1410 are arranged, capable, configured, and/or operable to communicate directly or indirectly with UEs 1412 and/or with other network nodes or equipment in telecommunication network 1402 to enable and/or provide network access, such as wireless network access, and/or to perform other functions, such as administration in telecommunication network 1402.

In the depicted example, core network 1406 connects network nodes 1410 to one or more hosts, such as host 1416. These connections may be direct or indirect via one or more intermediary networks or devices. In other examples, network nodes may be directly coupled to hosts. Core network 1406 includes one or more core network nodes (e.g., 1408) that are structured with hardware and software components. Features of these components may be substantially similar to those described with respect to the UEs, network nodes, and/or hosts, such that the descriptions thereof are generally applicable to the corresponding components of core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1416 may be under the ownership or control of a service provider other than an operator or provider of access network 1404 and/or telecommunication network 1402, and may be operated by the service provider or on behalf of the service provider. Host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1402 is a cellular network that implements 3GPP standardized features. Accordingly, telecommunication network 1402 may support network slicing to provide different logical networks to different devices that are connected to telecommunication network 1402. For example, telecommunication network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1412 are configured to transmit and/or receive information without direct human interaction. For instance, a UE may be designed to transmit information to access network 1404 on a predetermined schedule, when triggered by an internal or external event, or in response to requests from access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1414 communicates with access network 1404 to facilitate indirect communication between one or more UEs (e.g., UE 1412c and/or 1412d) and network nodes (e.g., network node 1410b). In some examples, hub 1414 may be a controller, router, content source and analytics, or any of the other communication devices described herein regarding UEs. For example, hub 1414 may be a broadband router enabling access to core network 1406 for the UEs. As another example, hub 1414 may be a controller that sends commands or instructions to one or more actuators in the UEs. Commands or instructions may be received from the UEs, network nodes 1410, or by executable code, script, process, or other instructions in hub 1414. As another example, hub 1414 may be a data collector that acts as temporary storage for UE data and, in some embodiments, may perform analysis or other processing of the data. As another example, hub 1414 may be a content source. For example, for a UE that is a VR headset, display, loudspeaker or other media delivery device, hub 1414 may retrieve VR assets, video, audio, or other media or data related to sensory information via a network node, which hub 1414 then provides to the UE either directly, after performing local processing, and/or after adding additional local content. In still another example, hub 1414 acts as a proxy server or orchestrator for the UEs, in particular in if one or more of the UEs are low energy IoT devices.

Hub 1414 may have a constant/persistent or intermittent connection to network node 1410b. Hub 1414 may also allow for a different communication scheme and/or schedule between hub 1414 and UEs (e.g., UE 1412c and/or 1412d), and between hub 1414 and core network 1406. In other examples, hub 1414 is connected to core network 1406 and/or one or more UEs via a wired connection. Moreover, hub 1414 may be configured to connect to an M2M service provider over access network 1404 and/or to another UE over a direct connection. In some scenarios, UEs may establish a wireless connection with network nodes 1410 while still connected via hub 1414 via a wired or wireless connection. In some embodiments, hub 1414 may be a dedicated hub—that is, a hub whose primary function is to route communications to/from the UEs from/to network node 1410b. In other embodiments, hub 1414 may be a non-dedicated hub—that is, a device which is capable of operating to route communications between the UEs and network node 1410b, but which is additionally capable of operating as a communication start and/or end point for certain data channels.

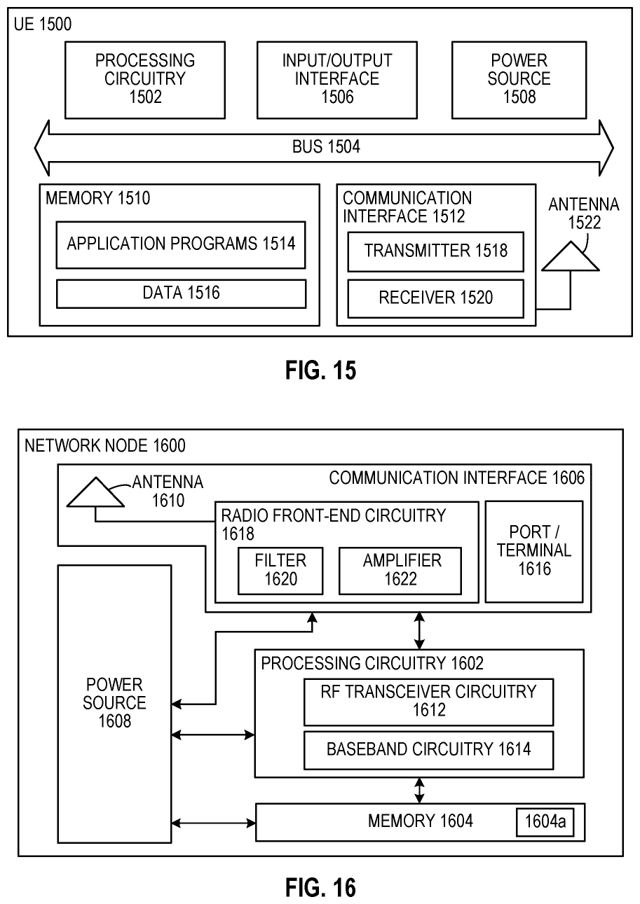

FIG. 15 shows a UE 1500 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1500 includes processing circuitry 1502 that is operatively coupled via bus 1504 to input/output interface 1506, power source 1508, memory 1510, communication interface 1512, and optionally to one or more other components not explicitly shown. Furthermore, certain UEs may utilize all or a subset of the components shown in FIG. 15. The level of integration between the components may vary from one UE to UE. Further, certain UEs may contain multiple instances of a component, such as multiple processors, memories, transceivers, transmitters, receivers, etc.

Processing circuitry 1502 is configured to process instructions and data and may be configured to implement any sequential state machine operative to execute instructions stored as machine-readable computer programs in memory 1510. Processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1502 may include multiple central processing units (CPUs).

In the example, input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1508 is structured as a battery or battery pack. Other types of power sources, such as an external power source (e.g., an electricity outlet), photovoltaic device, or power cell, may be used. Power source 1508 may further include power circuitry for delivering power from power source 1508 itself, and/or an external power source, to the various parts of UE 1500 via input circuitry or an interface such as an electrical power cable. Delivering power may be, for example, for charging power source 1508. Power circuitry may perform any formatting, converting, or other modification to the power from power source 1508 to make the power suitable for the respective components of UE 1500 to which power is supplied.

Memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1510 includes one or more application programs 1514, such as an operating system, web browser application, a widget, gadget engine, or other application, and corresponding data 1516. Memory 1510 may store, for use by UE 1500, any of a variety of various operating systems or combinations of operating systems.

Memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1510 may allow UE 1500 to access instructions, application programs and the like, stored on transitory or non-transitory memory media, to off-load data, or to upload data. An article of manufacture, such as one utilizing a communication system may be tangibly embodied as or in memory 1510, which may be or comprise a device-readable storage medium.

Processing circuitry 1502 may be configured to communicate with an access network or other network using communication interface 1512. Communication interface 1512 may comprise one or more communication subsystems and may include or be communicatively coupled to an antenna 1522. Communication interface 1512 may include one or more transceivers used to communicate, such as by communicating with one or more remote transceivers of another device capable of wireless communication (e.g., another UE or a network node in an access network). Each transceiver may include transmitter 1518 and/or receiver 1520 appropriate to provide network communications (e.g., optical, electrical, frequency allocations, and so forth). Moreover, transmitter 1518 and/or receiver 1520 may be coupled to one or more antennas (e.g., 1522) and may share circuit components, software or firmware, or alternatively be implemented separately.

In the illustrated embodiment, communication functions of communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

UE 1500 may provide an output of data captured by its sensors, regardless of type, through communication interface 1512 via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1600 includes processing circuitry 1602, memory 1604, communication interface 1606, and power source 1608. Network node 1600 may be composed of multiple physically separate components (e.g., a NodeB component and a RNC component, or a BTS component and a BSC component, etc.), which may each have their own respective components. In certain scenarios in which network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). Network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

Processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as memory 1604, to provide network node 1600 functionality.

In some embodiments, processing circuitry 1602 includes a system on a chip (SOC). In some embodiments, processing circuitry 1602 includes radio frequency (RF) transceiver circuitry 1612 and/or baseband processing circuitry 1614. In some embodiments, RF transceiver circuitry 1612 and baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

Memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1602. Memory 1604 may store any suitable instructions, data, or information, including a computer program, software, an application including one or more of logic, rules, code, tables, and/or other instructions (collectively denoted computer program 1604a, which may be in the form of a computer program product) capable of being executed by processing circuitry 1602 and utilized by network node 1600. Memory 1604 may be used to store any calculations made by processing circuitry 1602 and/or any data received via communication interface 1606. In some embodiments, processing circuitry 1602 and memory 1604 is integrated.

Communication interface 1606 is used in wired or wireless communication of signaling and/or data between a network node, access network, and/or UE. As illustrated, communication interface 1606 comprises port(s)/terminal(s) 1616 to send and receive data, for example to and from a network over a wired connection. Communication interface 1606 also includes radio front-end circuitry 1618 that may be coupled to, or in certain embodiments a part of, antenna 1610. Radio front-end circuitry 1618 comprises filters 1620 and amplifiers 1622. Radio front-end circuitry 1618 may be connected to an antenna 1610 and processing circuitry 1602. Radio front-end circuitry 1618 may be configured to condition signals communicated between antenna 1610 and processing circuitry 1602. Radio front-end circuitry 1618 may receive digital data that is to be sent out to other network nodes or UEs via a wireless connection. Radio front-end circuitry 1618 may convert the digital data into a radio signal having the appropriate channel and bandwidth parameters using a combination of filters 1620 and/or amplifiers 1622. The radio signal may then be transmitted via antenna 1610. Similarly, when receiving data, antenna 1610 may collect radio signals which are then converted into digital data by radio front-end circuitry 1618. The digital data may be passed to processing circuitry 1602. In other embodiments, the communication interface may comprise different components and/or different combinations of components.

In certain alternative embodiments, network node 1600 does not include separate radio front-end circuitry 1618, instead, processing circuitry 1602 includes radio front-end circuitry and is connected to antenna 1610. Similarly, in some embodiments, all or some of RF transceiver circuitry 1612 is part of communication interface 1606. In still other embodiments, communication interface 1606 includes one or more ports or terminals 1616, radio front-end circuitry 1618, and RF transceiver circuitry 1612, as part of a radio unit (not shown), and communication interface 1606 communicates with baseband processing circuitry 1614, which is part of a digital unit (not shown).

Antenna 1610 may include one or more antennas, or antenna arrays, configured to send and/or receive wireless signals. Antenna 1610 may be coupled to radio front-end circuitry 1618 and may be any type of antenna capable of transmitting and receiving data and/or signals wirelessly. In certain embodiments, antenna 1610 is separate from network node 1600 and connectable to network node 1600 through an interface or port.

Antenna 1610, communication interface 1606, and/or processing circuitry 1602 may be configured to perform any receiving operations and/or certain obtaining operations described herein as being performed by the network node. Any information, data and/or signals may be received from a UE, another network node and/or any other network equipment. Similarly, antenna 1610, communication interface 1606, and/or processing circuitry 1602 may be configured to perform any transmitting operations described herein as being performed by the network node. Any information, data and/or signals may be transmitted to a UE, another network node and/or any other network equipment.

Power source 1608 provides power to the various components of network node 1600 in a form suitable for the respective components (e.g., at a voltage and current level needed for each respective component). Power source 1608 may further comprise, or be coupled to, power management circuitry to supply the components of network node 1600 with power for performing the functionality described herein. For example, network node 1600 may be connectable to an external power source (e.g., the power grid, an electricity outlet) via an input circuitry or interface such as an electrical cable, whereby the external power source supplies power to power circuitry of power source 1608. As a further example, power source 1608 may comprise a source of power in the form of a battery or battery pack which is connected to, or integrated in, power circuitry. The battery may provide backup power should the external power source fail.

Embodiments of network node 1600 may include additional components beyond those shown in FIG. 16 for providing certain aspects of the network node's functionality, including any of the functionality described herein and/or any functionality necessary to support the subject matter described herein. For example, network node 1600 may include user interface equipment to allow input of information into network node 1600 and to allow output of information from network node 1600. This may allow a user to perform diagnostic, maintenance, repair, and other administrative functions for network node 1600.

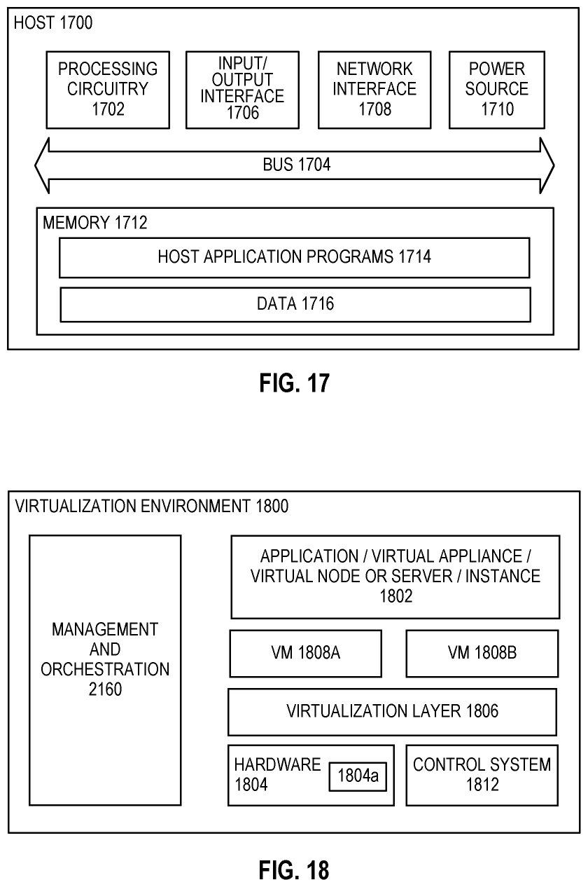

FIG. 17 is a block diagram of a host 1700, which may be an embodiment of host 1416 of FIG. 14, in accordance with various aspects described herein. As used herein, host 1700 may be or comprise various combinations hardware and/or software, including a standalone server, a blade server, a cloud-implemented server, a distributed server, a virtual machine, container, or processing resources in a server farm. Host 1700 may provide one or more services to one or more UEs.

Host 1700 includes processing circuitry 1702 that is operatively coupled via bus 1704 to input/output interface 1706, network interface 1708, power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

Memory 1712 may include one or more computer programs including one or more host application programs 1714 and data 1716, which may include user data, e.g., data generated by a UE for host 1700 or data generated by host 1700 for a UE. Embodiments of host 1700 may utilize only a subset or all of the components shown. Host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1714 may also provide for user authentication and licensing checks and may periodically report health, routes, and content availability to a central node, such as a device in or on the edge of a core network. Accordingly, host 1700 may select and/or indicate a different host for over-the-top services for a UE. Host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions (collectively denoted computer program 1804a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a-b (one or more of which may be generally referred to as VMs 1808), and/or perform any of the functions, features and/or benefits described in relation with some embodiments described herein. Virtualization layer 1806 may present a virtual operating platform that appears like networking hardware to VMs 1808.

VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1808 may be a software implementation of a physical machine that runs programs as if they were executing on a physical, non-virtualized machine. Each VM 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of hardware 1804 and corresponds to application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

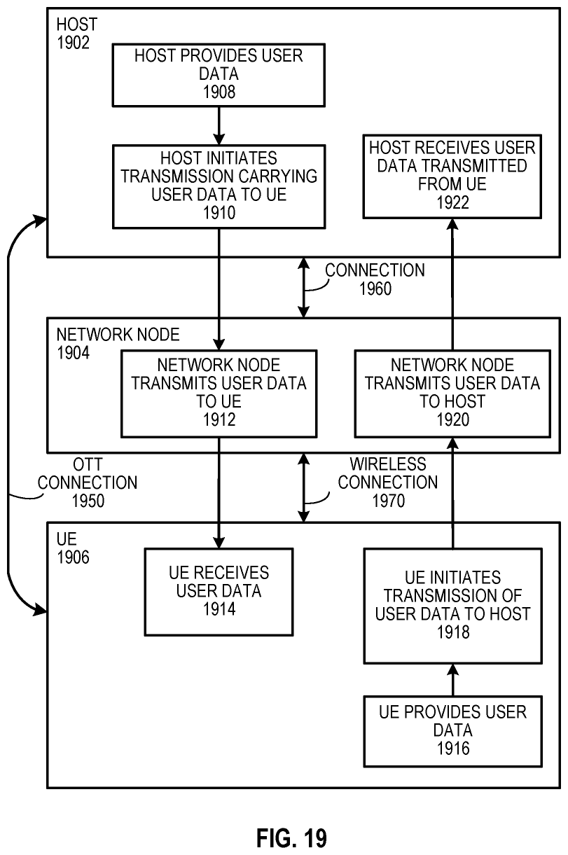

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. Host 1902 also includes software, which is stored in or accessible by host 1902 and executable by the processing circuitry. The software includes a host application that may be operable to provide a service to a remote user, such as UE 1906 connecting via an over-the-top (OTT) connection 1950 extending between UE 1906 and host 1902. In providing the service to the remote user, a host application may provide user data which is transmitted using OTT connection 1950.

Network node 1904 includes hardware enabling it to communicate with host 1902 and UE 1906. Connection 1960 may be direct or pass through a core network (like core network 1406 of FIG. 14) and/or one or more other intermediate networks, such as one or more public, private, or hosted networks. For example, an intermediate network may be a backbone network or the Internet.

UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of host 1902. In host 1902, an executing host application may communicate with the executing client application via OTT connection 1950 terminating at UE 1906 and host 1902. In providing the service to the user, the UE's client application may receive request data from the host's host application and provide user data in response to the request data. OTT connection 1950 may transfer both the request data and the user data. The UE's client application may interact with the user to generate the user data that it provides to the host application through OTT connection 1950.

OTT connection 1950 may extend via a connection 1960 between host 1902 and network node 1904 and via a wireless connection 1970 between network node 1904 and UE 1906 to provide the connection between host 1902 and UE 1906. Connection 1960 and wireless connection 1970, over which OTT connection 1950 may be provided, have been drawn abstractly to illustrate the communication between host 1902 and UE 1906 via network node 1904, without explicit reference to any intermediary devices and the precise routing of messages via these devices.

As an example of transmitting data via OTT connection 1950, in step 1908, host 1902 provides user data, which may be performed by executing a host application. In some embodiments, the user data is associated with a particular human user interacting with UE 1906. In other embodiments, the user data is associated with a UE 1906 that shares data with host 1902 without explicit human interaction. In step 1910, host 1902 initiates a transmission carrying the user data towards UE 1906. Host 1902 may initiate the transmission responsive to a request transmitted by UE 1906. The request may be caused by human interaction with UE 1906 or by operation of the client application executing on UE 1906. The transmission may pass via network node 1904, in accordance with the teachings of the embodiments described throughout this disclosure. Accordingly, in step 1912, network node 1904 transmits to UE 1906 the user data that was carried in the transmission that host 1902 initiated, in accordance with the teachings of the embodiments described throughout this disclosure. In step 1914, UE 1906 receives the user data carried in the transmission, which may be performed by a client application executed on UE 1906 associated with the host application executed by host 1902.

In some examples, UE 1906 executes a client application which provides user data to host 1902. The user data may be provided in reaction or response to the data received from host 1902. Accordingly, in step 1916, UE 1906 may provide user data, which may be performed by executing the client application. In providing the user data, the client application may further consider user input received from the user via an input/output interface of UE 1906. Regardless of the specific manner in which the user data was provided, UE 1906 initiates, in step 1918, transmission of the user data towards host 1902 via network node 1904. In step 1920, in accordance with the teachings of the embodiments described throughout this disclosure, network node 1904 receives user data from UE 1906 and initiates transmission of the received user data towards host 1902. In step 1922, host 1902 receives the user data carried in the transmission initiated by UE 1906.

One or more of the various embodiments improve the performance of OTT services provided to UE 1906 using OTT connection 1950, in which wireless connection 1970 forms the last segment. For example, by improving the configuration for fast MCG recovery used in a cell, the RAN can reduce average UE delay for connection recovery after a detecting failure condition in the MCG. In this manner, embodiments reduce average connection interruption time for UEs experiencing MCG failures, thereby reducing UE energy consumption and improving end-user experience. At a high level, embodiments can improve DC operations for both UEs and RANs. When used to deliver OTT services to end users, UEs and RANs improved in this manner increase the value of the OTT services to the end users and to OTT service providers.

In an example scenario, factory status information may be collected and analyzed by host 1902. As another example, host 1902 may process audio and video data which may have been retrieved from a UE for use in creating maps. As another example, host 1902 may collect and analyze real-time data to assist in controlling vehicle congestion (e.g., controlling traffic lights). As another example, host 1902 may store surveillance video uploaded by a UE. As another example, host 1902 may store or control access to media content such as video, audio, VR or AR which it can broadcast, multicast or unicast to UEs. As other examples, host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1950 between host 1902 and UE 1906, in response to variations in the measurement results. The measurement procedure and/or the network functionality for reconfiguring the OTT connection may be implemented in software and hardware of host 1902 and/or UE 1906. In some embodiments, sensors (not shown) may be deployed in or in association with other devices through which OTT connection 1950 passes; the sensors may participate in the measurement procedure by supplying values of the monitored quantities exemplified above, or supplying values of other physical quantities from which software may compute or estimate the monitored quantities. The reconfiguring of OTT connection 1950 may include message format, retransmission settings, preferred routing etc.; the reconfiguring need not directly alter the operation of network node 1904. Such procedures and functionalities may be known and practiced in the art. In certain embodiments, measurements may involve proprietary UE signaling that facilitates measurements of throughput, propagation times, latency and the like, by host 1902. The measurements may be implemented in that software causes messages to be transmitted, in particular empty or ‘dummy’ messages, using OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to communicate with a radio access network (RAN) via a master cell group (MCG) provided by a first RAN node and a secondary cell group (SCG) provided by a second RAN node, the method comprising:
   detecting a failure condition in the MCG;
   based on determining that the SCG is neither deactivated nor suspended, transmitting an MCG failure report to the second RAN node via the SCG and initiating a fast MCG recovery timer;
   storing information associated with the fast MCG recovery procedure; and
   subsequently transmitting, to a third RAN node, a message including the information associated with the fast MCG recovery procedure.
A2. The method of embodiment A1, wherein the information associated with the fast MCG recovery procedure includes one or more of the following:
   an initial value used by the UE to initiate the fast MCG recovery timer;
   a first indication of whether the fast MCG recovery timer expired before the UE received a responsive message;
   an identity of the SCG cell to which the UE transmitted the MCG failure report;
   an identity of the MCG cell in which the UE detected the failure condition;
   time elapsed between the UE detecting the failure condition in the MCG and transmitting the MCG failure report; and
A3. The method of any of embodiments A1-A2, further comprising:
   receiving a responsive message from the second RAN node while the fast MCG recovery timer is running; and
   stopping the fast MCG recovery timer upon receiving the responsive message.
A4. The method of embodiment A3, wherein the responsive message is one of the following: RRCRelease, RRCReconfiguration with reconfigurationwithSync for a primary cell (PCell) of the MCG, and MobilityFromNRCommand.
A5. The method of any of embodiments A3-A4, wherein the information associated with the fast MCG recovery procedure includes one or more of the following:
   terminal value of the fast MCG recovery timer;
   time elapsed between initiating the fast MCG recovery timer and receiving the responsive message;
   most recent MCG and/or SCG radio measurement results before stopping the fast MCG recovery timer;
   an identity of a target MCG primary cell (PCell) indicated in the responsive message;
   a type of the responsive message; and
   time elapsed between detecting the failure condition and receiving the responsive message.
A6. The method of any of embodiments A1-A5, where the message including the information associated with the fast MCG recovery procedure is one of the following: a successful fast MCG recovery report, a successful handover report (SHR), an RRCSetupComplete message, and an RRCReestablishmentComplete message.
A7. The method of any of embodiments A1-A2, further comprising, upon expiry of the fast MCG recovery timer without receiving a responsive message from the second RAN node, initiating a connection reestablishment procedure with the RAN.
A8. The method of embodiment A7, where the message including the information associated with the fast MCG recovery procedure is one of the following: a radio link failure (RLF) report, or an RRCReconfigurationComplete message.
A9. The method of any of embodiments A7-A8, wherein the information associated with the fast MCG recovery procedure includes one or more of the following:
   time elapsed between the UE detecting the failure condition and initiating the connection reestablishment procedure;
   most recent MCG and/or SCG radio measurement results before expiry of the fast MCG recovery timer;
   an identity of a target MCG PCell towards which the UE initiated the connection reestablishment procedure;
   an indication of whether the UE successfully completed the connection reestablishment procedure; and
   time elapsed between the UE detecting the failure condition in the MCG and successful completion of the connection reestablishment procedure.
A10. The method of any of embodiments A1-A9, further comprising receiving from the first RAN node or the second node a configuration for fast MCG recovery, wherein:
   the configuration includes an initial value for the fast MCG recovery timer, and
   initiating the fast MCG recovery time is based on the received initial value.
A11. The method of any of embodiments A1-A10, wherein the message is transmitted to the third RAN node in one of the following cells:
   a cell in which the UE successfully completed a connection reestablishment procedure;
   a cell in which the UE connected to the RAN after a failed connection reestablishment procedure; or
   a cell to which the UE performed a handover.
B1. A method for a third RAN node configured to communicate with a user equipment (UE) via a cell, the method comprising:
   receiving, from the UE via the cell, a message including information associated with a fast MCG recovery procedure performed by the UE after detecting a failure condition in the UE's master cell group (MCG);
   based on the received information, determining that the MCG in which the failure condition was detected was provided by a first RAN node; and
   sending to the first RAN node at least a portion of the information associated with the fast MCG recovery procedure performed by the UE.
B2. The method of embodiment B1, wherein the information associated with the fast MCG recovery procedure includes one or more of the following:
   an initial value used by the UE to initiate a fast MCG recovery timer;
   a first indication of whether the UE received a responsive message from the RAN before the fast MCG recovery timer expired;
   an identity of the SCG cell to which the UE transmitted the MCG failure report;
   an identity of the MCG cell in which the UE detected the failure condition;
   time elapsed between the UE detecting the failure condition in the MCG and transmitting the MCG failure report; and
   UE location-related information associated with the detected failure condition.
B3. The method of embodiment B2, wherein when the UE received a responsive message before the fast MCG recovery timer expired, the information associated with the fast MCG recovery procedure also includes one or more of the following:
   terminal value of the fast MCG recovery timer;
   time elapsed between the UE initiating the fast MCG recovery timer and receiving the responsive message;
   most recent MCG and/or SCG radio measurement results before stopping the fast MCG recovery timer and/or receiving the responsive message;
   an identity of a target MCG primary cell (PCell) indicated in the responsive message;
   a type of the responsive message; and
   time elapsed between the UE detecting the failure condition and receiving the responsive message.
B4. The method of embodiment B3, wherein the type of the responsive message is one of the following: RRCRelease, RRCReconfiguration with reconfigurationwithSync for a primary cell (PCell) of the MCG, and MobilityFromNRCommand.
B5. The method of any of embodiments B3-B4, where the message including the information associated with the fast MCG recovery procedure is one of the following: a successful fast MCG recovery report, a successful handover report (SHR), an RRCSetupComplete message, and an RRCReestablishmentComplete message.
B6. The method of embodiment B2, wherein when the fast MCG recovery timer expired without the UE receiving a responsive message, the information associated with the fast MCG recovery procedure also includes one or more of the following:
   time elapsed between the UE detecting the failure condition and initiating a connection reestablishment procedure;
   most recent MCG and/or SCG radio measurement results before expiry of the fast MCG recovery timer;
   an identity of a target MCG PCell towards which the UE initiated the connection reestablishment procedure;
   an indication of whether the UE successfully completed the connection reestablishment procedure; and
   time elapsed between the UE detecting the failure condition in the MCG and successfully completing the connection reestablishment procedure.
B7. The method of embodiment B6, where the message including the information associated with the fast MCG recovery procedure is one of the following: a radio link failure (RLF) report, or an RRCReconfigurationComplete message.
B8. The method of any of embodiments B1-B7, wherein the cell via which the third RAN received the message is one of the following:
   a cell in which the UE successfully completed a connection reestablishment procedure;
   a cell in which the UE connected to the RAN after a failed connection reestablishment procedure; or
   a cell to which the UE performed a handover.
B9. The method of any of embodiments B1-B8, wherein the at least a portion of the information associated with the fast MCG recovery procedure is sent to the first RAN node in one of the following messages: XnAP ACCESS AND MOBILITY INDICATION, or XnAP FAILURE INDICATION.
C1. A method for a first radio access network (RAN) node configured to provide a master cell group (MCG) for a user equipment (UE) that is also configured to communicate with the RAN via a secondary cell group (SCG) provided by a second RAN node, the method comprising:
   receiving, from a third RAN node, a message including information associated with a fast MCG recovery procedure performed by the UE after detecting a failure condition in the MCG;
   based on the received information, identifying a cell served by the first RAN node in which failure condition was detected; and
   based on the received information, adjusting a configuration for fast MCG recovery associated with the identified cell.
C2. The method of embodiment C1, wherein the information associated with the fast MCG recovery procedure includes one or more of the following:
   an initial value used by the UE to initiate a fast MCG recovery timer;
   a first indication of whether the UE received a responsive message from the RAN before the fast MCG recovery timer expired;
   an identity of the SCG cell to which the UE transmitted the MCG failure report;
   an identity of the MCG cell in which the UE detected the failure condition;
   time elapsed between the UE detecting the failure condition in the MCG and transmitting the MCG failure report; and
   UE location-related information associated with the detected failure condition.
C3. The method of embodiment C2, wherein when the UE received a responsive message before the fast MCG recovery timer expired, the information associated with the fast MCG recovery procedure also includes one or more of the following:
   terminal value of the fast MCG recovery timer;
   time elapsed between the UE initiating the fast MCG recovery timer and receiving the responsive message;
   most recent MCG and/or SCG radio measurement results before stopping the fast MCG recovery timer and/or receiving the responsive message;
   an identity of a target MCG primary cell (PCell) indicated in the responsive message;
   a type of the responsive message; and
   time elapsed between the UE detecting the failure condition and receiving the responsive message.
C4. The method of embodiment B3, wherein the type of the responsive message is one of the following: RRCRelease, RRCReconfiguration with reconfigurationwithSync for a primary cell (PCell) of the MCG, and MobilityFromNRCommand.
C5. The method of embodiment C2, wherein when the fast MCG recovery timer expired without the UE receiving a responsive message, the information associated with the fast MCG recovery procedure also includes one or more of the following:
   time elapsed between the UE detecting the failure condition and initiating a connection reestablishment procedure;
   most recent MCG and/or SCG radio measurement results before expiry of the fast MCG recovery timer;
   an identity of a target MCG PCell towards which the UE initiated the connection reestablishment procedure;
   an indication of whether the UE successfully completed the connection reestablishment procedure; and
   time elapsed between the UE detecting the failure condition in the MCG and successfully completing the connection reestablishment procedure.
C6. The method of any of embodiments C1-C5, wherein the information associated with the fast MCG recovery procedure is received from to the third RAN node in one of the following messages: XnAP ACCESS AND MOBILITY INDICATION, or XnAP FAILURE INDICATION.
C7. The method of any of embodiments C1-C6, wherein:
   the configuration for fast MCG recovery includes an initial value for a fast MCG recovery timer; and
   adjusting the configuration of fast MCG recovery includes increasing or decreasing the initial value for a fast MCG recovery timer based on one or more of the following included in the received information associated with the fast MCG recovery procedure:
      a first indication of whether the UE received a responsive message from the RAN before the fast MCG recovery timer expired;
      time elapsed between the UE detecting the failure condition in the MCG and transmitting an MCG failure report; and
      terminal value of the fast MCG recovery timer, when the UE received the responsive message;
      time elapsed between the UE detecting the failure condition and receiving the responsive message.
      time elapsed between the UE initiating the fast MCG recovery timer and receiving the responsive message;
      time elapsed between the UE detecting the failure condition and initiating a connection reestablishment procedure;
      an indication of whether the UE successfully completed the connection reestablishment procedure; and
      time elapsed between the UE detecting the failure condition and successfully completing the connection reestablishment procedure.
C8. The method of any of embodiments C1-C7, wherein adjusting the configuration of fast MCG recovery includes modifying rules for selecting an SCG and/or a primary SCG cell (PSCell) in combination with the identified cell as a primary cell (PCell) of an MCG for a UE, based on one or more of the following included in the received information associated with the fast MCG recovery procedure:
   a first indication of whether the UE received a responsive message from the RAN before the fast MCG recovery timer expired;
   an identity of the SCG cell to which the UE transmitted the MCG failure report;
   UE location-related information associated with the detected failure condition;
   most recent MCG and/or SCG radio measurement results before stopping the fast MCG recovery timer and/or receiving the responsive message;
   most recent MCG and/or SCG radio measurement results before expiry of the fast MCG recovery timer; and
   time elapsed between the UE detecting the failure condition and receiving the responsive message.
C9. The method of any of embodiments C1-C8, further comprising sending to the UE a configuration for fast MCG recovery, wherein:
   the configuration includes an initial value for a fast MCG recovery timer; and
   the fast MCG recovery procedure performed by the UE after detecting a failure condition in the MCG is based on the initial value.
C10. The method of any of embodiments C1-C9, wherein the third RAN node, from which the message is received, serves one of the following cells:
   a cell in which the UE successfully completed a connection reestablishment procedure;
   a cell in which the UE connected to the RAN after a failed connection reestablishment procedure; or
   a cell to which the UE performed a handover.
D1. A user equipment (UE) configured to communicate with a radio access network (RAN) via a master cell group (MCG) provided by a first RAN node and a secondary cell group (SCG) provided by a second RAN node, the UE comprising:
   communication interface circuitry configured to communicate with the RAN via the SCG and the MCG; and
   processing circuitry operatively coupled to the radio transceiver circuitry, whereby the processing circuitry and the radio transceiver circuitry are configured to perform operations corresponding to any of the methods of embodiments A1-A10.
D2. A user equipment (UE) configured to communicate with a radio access network (RAN) via a master cell group (MCG) provided by a first RAN node and a secondary cell group (SCG) provided by a second RAN node, the UE being further configured to perform operations corresponding to any of the methods of embodiments A1-A10.
D3. A non-transitory, computer-readable medium storing computer-executable instructions that, when executed by processing circuitry of a user equipment (UE) configured to communicate with a radio access network (RAN) via a master cell group (MCG) provided by a first RAN node and a secondary cell group (SCG) provided by a second RAN node, configure the UE to perform operations corresponding to any of the methods of embodiments A1-A10.
D4. A computer program product comprising computer-executable instructions that, when executed by processing circuitry of a user equipment (UE) configured to communicate with a radio access network (RAN) via a master cell group (MCG) provided by a first RAN node and a secondary cell group (SCG) provided by a second RAN node, configure the UE to perform operations corresponding to any of the methods of embodiments A1-A10.
E1. A third radio access network (RAN) node configured to communicate with a user equipment (UE) via a cell, the third RAN node comprising:
   communication interface circuitry configured to communicate with the UE and with a first RAN node; and
   processing circuitry operatively coupled to the communication interface circuitry, whereby the processing circuitry and the communication interface circuitry are configured to perform operations corresponding to any of the methods of embodiments B1-B9.
E2. A third radio access network (RAN) node configured to communicate with a user equipment (UE) via a cell, the third RAN node being further configured to perform operations corresponding to any of the methods of embodiments B1-B9.
E3. A non-transitory, computer-readable medium storing computer-executable instructions that, when executed by processing circuitry of a third radio access network (RAN) node configured to communicate with a user equipment (UE) via a cell, configure the third RAN node to perform operations corresponding to any of the methods of embodiments B1-B9.
E4. A computer program product comprising computer-executable instructions that, when executed by processing circuitry of a third radio access network (RAN) node configured to communicate with a user equipment (UE) via a cell, configure the third RAN node to perform operations corresponding to any of the methods of embodiments B1-B9.
F1. A first radio access network (RAN) node configured to provide a master cell group (MCG) for a user equipment (UE) that is also configured to communicate with the RAN via a secondary cell group (SCG) provided by a second RAN node, the first RAN node comprising:
   communication interface circuitry configured to communicate with the UE via the MCG and with a third RAN node; and
   processing circuitry operatively coupled to the communication interface circuitry, whereby the processing circuitry and the communication interface circuitry are configured to perform operations corresponding to any of the methods of embodiments C1-C10.
F2. A first radio access network (RAN) node configured to provide a master cell group (MCG) for a user equipment (UE) that is also configured to communicate with the RAN via a secondary cell group (SCG) provided by a second RAN node, the first RAN node being further configured to perform operations corresponding to any of the methods of embodiments C1-C10.
F3. A non-transitory, computer-readable medium storing computer-executable instructions that, when executed by processing circuitry of a first radio access network (RAN) node configured to provide a master cell group (MCG) for a user equipment (UE) that is also configured to communicate with the RAN via a secondary cell group (SCG) provided by a second RAN node, configure the first RAN node to perform operations corresponding to any of the methods of embodiments C1-C10.
F4. A computer program product comprising computer-executable instructions that, when executed by processing circuitry of a first radio access network (RAN) node configured to provide a master cell group (MCG) for a user equipment (UE) that is also configured to communicate with the RAN via a secondary cell group (SCG) provided by a second RAN node, configure the first RAN node to perform operations corresponding to any of the methods of embodiments C1-C10.

1.-50. (canceled)

51. A method for a user equipment (UE) configured to communicate with a radio access network (RAN) via a master cell group (MCG) provided by a first RAN node and a secondary cell group (SCG) provided by a second RAN node, the method comprising:
based on detecting a failure condition in the MCG and determining that the SCG is neither deactivated nor suspended, transmitting an MCG failure report to the second RAN node via the SCG and initiating a timer associated with a fast MCG recovery procedure;
storing information associated with the fast MCG recovery procedure; and
subsequently transmitting, to a third RAN node, a message including the information associated with the fast MCG recovery procedure.

52. The method of claim 51, wherein:
the message including the information associated with the fast MCG recovery procedure is one of the following: a successful fast MCG recovery report, a successful handover report (SHR), and a radio link failure (RLF) report; and
the information associated with the fast MCG recovery procedure includes one or more of the following:
a RAN-configured value for the timer;
an indication of whether the timer expired before the UE received a responsive message;
an identity of the SCG cell to which the UE transmitted the MCG failure report;
an identity of the MCG cell in which the UE detected the failure condition;
time elapsed between the UE detecting the failure condition in the MCG and transmitting the MCG failure report; and
UE location-related information associated with the detected failure condition in the MCG.

53. The method of claim 52, further comprising:
receiving a responsive message from the second RAN node while the timer is running, wherein the responsive message is one of the following: RRCRelease, RRCReconfiguration with reconfigurationwithSync for a primary cell (PCell) of the MCG or MobilityFromNRCommand for the PCell of the MCG; and
stopping the timer upon receiving the responsive message,
wherein the information associated with the fast MCG recovery procedure also includes one or more of the following:
value of the timer at reception of the responsive message;
time elapsed between initiating the timer and receiving the responsive message;
most recent MCG and/or SCG radio measurement results before stopping the timer;
an identity of a target MCG primary cell, PCell, indicated in the responsive message;
a type of the responsive message; and
time elapsed between detecting the failure condition in the MCG and receiving the responsive message.

54. The method of claim 52, further comprising, upon expiry of the timer without receiving a responsive message from the second RAN node, initiating a connection reestablishment procedure with the RAN, wherein the information associated with the fast MCG recovery procedure also includes one or more of the following:
time elapsed between the detecting the failure condition in the MCG and initiating the connection reestablishment procedure;
most recent MCG and/or SCG radio measurement results before expiry of the timer;
an identity of a target MCG PCell towards which the UE initiated the connection reestablishment procedure;
an indication of whether the UE successfully completed the connection reestablishment procedure; and
time elapsed between detecting the failure condition in the MCG and successful completion of the connection reestablishment procedure.

55. The method of claim 51, further comprising:
transmitting, to the third RAN node, an indication of availability of stored information associated with a fast MCG recovery procedure; and
receiving from the third RAN node a request for the stored information associated with the fast MCG recovery procedure,
wherein the message including the information associated with the fast MCG recovery procedure is transmitted to the third RAN node in response to the request.

56. The method of claim 55, wherein one of the following applies:
the indication is included in an RRCReestablishmentComplete message transmitted in a cell in which the UE successfully completed a connection reestablishment procedure;
the indication is included in an RRCSetupComplete message transmitted in a cell in which the UE connected to the RAN after a failed connection reestablishment procedure;
the indication is included in an RRCReconfigurationComplete message transmitted in a cell to which the UE performed a handover; or
the indication is included in an RRCResumeComplete message transmitted in a cell in which the UE returned to RRC_CONNECTED state.

57. A method for a third RAN node configured to communicate with a user equipment (UE) via a cell, the method comprising:
receiving, from the UE via the cell, a message including information associated with a fast master cell group (MCG) recovery procedure performed by the UE after UE detection of a failure condition in the UE's MCG and UE transmission of an MCG failure report to a second RAN node via the UE's secondary cell group (SCG);
based on the received information, determining that the MCG in which the failure condition was detected was provided by a first RAN node; and
sending to the first RAN node at least a portion of the information associated with the fast MCG recovery procedure performed by the UE.

58. The method of claim 57, wherein:
the message including the information associated with the fast MCG recovery procedure is one of the following: a successful fast MCG recovery report, a successful handover report (SHR), or a radio link failure (RLF) report; and
the information associated with the fast MCG recovery procedure includes one or more of the following:
a RAN-configured value for a UE timer associated with the fast MCG recovery procedure;
an indication of whether the UE received a responsive message from the RAN before the UE timer expired;
an identity of the SCG cell to which the UE transmitted the MCG failure report;
an identity of the MCG cell in which the UE detected the failure condition;
time elapsed between UE detection of the failure condition in the MCG and UE transmission of the MCG failure report; and
UE location-related information associated with the detected failure condition in the MCG.

59. The method of claim 58, wherein when the UE received a message responsive to the MCG failure report from the second RAN node before the timer expired, the information associated with the fast MCG recovery procedure also includes one or more of the following:
value of the UE timer at UE reception of the responsive message;
time elapsed between UE initiation of the UE timer and UE reception of the responsive message;
most recent MCG and/or SCG radio measurement results before the UE stopped the UE timer and/or the UE received the responsive message;
an identity of a target MCG primary cell (PCell) indicated in the responsive message;
a type of the responsive message; and
time elapsed between UE detection of the failure condition and UE reception of the responsive message.

60. The method of claim 58, wherein when the timer expired without the UE receiving a message responsive to the MCG failure report from the second RAN node, the information associated with the fast MCG recovery procedure also includes one or more of the following:
time elapsed between UE detection of the failure condition and UE initiation of a connection reestablishment procedure;
most recent MCG and/or SCG radio measurement results before expiry of the UE timer;
an identity of a target MCG PCell towards which the UE initiated the connection reestablishment procedure;
an indication of whether the UE successfully completed the connection reestablishment procedure; and
time elapsed between UE detection of the failure condition in the MCG and successful UE completion of the connection reestablishment procedure.

61. The method of claim 57, further comprising:
receiving from the UE an indication of availability of stored information associated with a fast MCG recovery procedure; and
transmitting to the UE a request for the stored information associated with the fast MCG recovery procedure,
wherein the message including the information associated with the fast MCG recovery procedure is received from the UE in response to the request.

62. The method of claim 61, wherein one of the following applies:
the indication is included in an RRCReestablishmentComplete message received in a cell in which the UE successfully completed a connection reestablishment procedure;
the indication is included in an RRCSetupComplete message received in a cell in which the UE connected to the RAN after a failed connection reestablishment procedure;
the indication is included in an RRCReconfigurationComplete message received in a cell to which the UE performed a handover; or
the indication is included in an RRCResumeComplete message received in a cell in which the UE returned to RRC_CONNECTED state.

63. A method for a first radio access network (RAN) node configured to provide a master cell group (MCG) for a user equipment (UE) that is also configured to communicate with the RAN via a secondary cell group (SCG) provided by a second RAN node, the method comprising:
receiving, from a third RAN node, a message including information associated with a fast MCG recovery procedure performed by the UE after UE detection of a failure condition in the MCG and UE transmission of an MCG failure report to the second RAN node via the SCG;
based on the received information, identifying a cell served by the first RAN node in which failure condition was detected; and
based on the received information, adjusting a configuration for fast MCG recovery associated with the identified cell.

64. The method of claim 63, wherein:
the message including the information associated with the fast MCG recovery procedure is one of the following: a successful fast MCG recovery report, a successful handover report (SHR), or a radio link failure (RLF) report; and
the information associated with the fast MCG recovery procedure includes one or more of the following:
a RAN-configured value for a UE timer associated with the fast MCG recovery procedure;
an indication of whether the UE received a responsive message from the RAN before the UE timer expired;
an identity of the SCG cell to which the UE transmitted the MCG failure report;
an identity of the MCG cell in which the UE detected the failure condition;
time elapsed between UE detection of the failure condition in the MCG and UE transmission of the MCG failure report; and
UE location-related information associated with the detected failure condition in the MCG.

65. The method of claim 64, wherein when the UE received a message responsive to the MCG failure report from the second RAN node before the timer expired, the information associated with the fast MCG recovery procedure also includes one or more of the following:
value of the UE timer at reception of the responsive message;
time elapsed between UE initiation of the UE timer and UE reception of the responsive message;
most recent MCG and/or SCG radio measurement results before the UE stopped the UE timer and/or the UE received the responsive message;
an identity of a target MCG primary cell, PCell, indicated in the responsive message;
a type of the responsive message; and
time elapsed between UE detection of the failure condition and UE reception of the responsive message.

66. The method of claim 64, wherein when the timer expired without the UE receiving a message responsive to the MCG failure report from the second RAN node, the information associated with the fast MCG recovery procedure also includes one or more of the following:
time elapsed between UE detection of the failure condition and UE initiation of a connection reestablishment procedure;
most recent MCG and/or SCG radio measurement results before expiry of the UE timer;
an identity of a target MCG PCell towards which the UE initiated the connection reestablishment procedure;
an indication of whether the UE successfully completed the connection reestablishment procedure; and
time elapsed between UE detection of the failure condition in the MCG and successful UE completion of the connection reestablishment procedure.

67. The method of claim 63, wherein:
the configuration for fast MCG recovery includes a RAN-configured value for a UE timer associated with the fast MCG recovery procedure; and
adjusting the configuration of fast MCG recovery includes increasing or decreasing the RAN-configured value for the UE timer based on one or more of the following included in the received information associated with the UE's fast MCG recovery procedure:
an indication of whether the UE received a responsive message from the RAN before the timer expired;
time elapsed between UE detection of the failure condition in the MCG and transmitting an MCG failure report;
value of the UE timer at UE reception of the responsive message;
time elapsed between UE detection of the failure condition and UE reception of the responsive message;
time elapsed between UE initiation of the UE timer and UE reception of the responsive message;
time elapsed between UE detection of the failure condition and UE initiation of a connection reestablishment procedure;
an indication of whether the UE successfully completed the connection reestablishment procedure; and
time elapsed between UE detection of the failure condition in the MCG and successful UE completion of the connection reestablishment procedure.

68. The method of claim 63, wherein adjusting the configuration of fast MCG recovery includes modifying rules for selecting an SCG and/or a primary SCG cell (PSCell) in combination with the identified cell as a primary cell (PCell) of an MCG for a UE, based on one or more of the following included in the received information associated with the fast MCG recovery procedure:
an indication of whether the UE received a responsive message from the RAN before expiry of a UE timer associated with the fast MCG recovery procedure;
an identity of the SCG cell to which the UE transmitted the MCG failure report;
UE location-related information associated with the detected failure condition in the MCG;
most recent MCG and/or SCG radio measurement results before the UE stopped the UE timer and/or the UE received the responsive message;
most recent MCG and/or SCG radio measurement results before expiry of the UE timer; and
time elapsed between UE detection of the failure condition and UE reception of the responsive message.

69. A user equipment (UE) configured to communicate with a radio access network (RAN) via a master cell group (MCG) provided by a first RAN node and a secondary cell group (SCG) provided by a second RAN node, the UE comprising:
communication interface circuitry configured to communicate with the RAN; and
processing circuitry operatively coupled to the communication interface circuitry, wherein the processing circuitry and the communication interface circuitry are configured to perform the method of claim 51.

70. A third radio access network (RAN) node configured to communicate with a user equipment (UE) via a cell, the third RAN node comprising:
communication interface circuitry configured to communicate with the UE and with a first RAN node; and
processing circuitry operatively coupled to the communication interface circuitry, whereby the processing circuitry and the communication interface circuitry are configured to perform the method of claim 57.
